(19) United States
(12) Patent Application Publication
(10) Pub. No.: US 2005/0154664 A1
(43) Pub. Date: Jul. 14, 2005

(54) Credit and financial information and management system

(76) Inventors: Keith Alan Guy, Shell Beach, CA (US); Alexander Abraham Balke, Templeton, CA (US); Clinton A. Staley, Atascadero, CA (US); Anthony Wilson, San Luis Obispo, CA (US)

Correspondence Address: MARK J. SPOLYAR, 38 FOUNTAIN ST., SAN FRANCISCO, CA, 94114, US

(21) Appl. No.: 11/068,145

(22) Filed: Feb. 28, 2005

Related U.S. Application Data
(63) Continuation of application No. 09/644,139, filed on Aug. 22, 2000, now abandoned.

(51) Int. Cl. G06F 7/00

(52) U.S. Cl. 705/35

(57) ABSTRACT

Methods and apparatuses relating to the provision of credit and financial services. In one embodiment, the present invention provides-user authentication protocols facilitating the electronic delivery of credit reports over a computer network directly to users. According to one embodiment of the invention, a credit report comprises a particular user's credit history and other financial information, and/or a credit rating. Other embodiments of the present invention allow for the provision of services related to consumer and business credit report data.

### FIELD OF THE INVENTION

The present invention relates to credit and financial services and, in part, relates to the on-line or electronic delivery of credit and financial reports over a computer network.

### BACKGROUND OF THE INVENTION

The increasing use of wide area networks such as the Internet has resulted in an explosion in the provision of on-line services. Indeed, the Internet age has seen the emergence of a virtual or cyber-world that offers many of the goods and services available in the off-line or real world and more. For example, so-called “e-tailers,” like Amazon.com and Buy.com allows users to shop on-line for consumer goods and services, such as books and electronics. E-Bay allows users to post items for sale in on-line auctions. Traditional “bricks and mortar” services, such as banks, have also expanded their services to the Internet. In addition, other businesses have also emerged that take advantage of wide area networks, like the Internet. For example, Priceline.com has established a “reverse” auction allowing users to place binding offers to buy goods or services at a desired price.

The Internet is a global network of millions of computers belonging to various commercial and non-profit entities, such as corporations, universities, and research organizations. The computer networks of the Internet are connected by gateways that handle data transfer and conversion of messages from a sending network to the protocols used by a receiving network. The Internet's collection of networks and gateways use the TCP/IP protocol. TCP/IP is an acronym for Transmission Control Protocol/Internet Protocol, a software protocol developed by the Department of Defense.

Typically, the computers connected to a wide area network such as the Internet are identified as either servers or clients. A server is a computer that stores files that are available to other computers connected to the network. A client is a computer connected to the network that accesses the files and other resources provided by a server. To obtain information from a server, a client computer makes a request for a file or information located on the server using a specified protocol. Upon receipt of a properly formatted request, the server downloads the file to the client computer.

Users can access content on the Internet and the World Wide Web with an Internet Browser, which is a software application used to locate and display web pages. A Web page is a document on the World Wide Web. Every Web page or file on a web server is identified by a unique Uniform Resource Locator. A Uniform Resource Locator (“URL”) is the global address of files and other resources on the Internet. The address indicates the protocol being used and specifies the IP address or the domain name where the file or resource is located. Typically, a URL identifies the name of the server and the path to a desired file on the server. For example, a URL for a particular file on a web server may be constructed as follows: “http://<server>/<filepath>”. where <server> identifies the server on which the file is located and <filepath> identifies the path to the file on the server. Thus, with the name of the server and the correct path to a file, a properly formatted URL accesses a desired file on a server connected to the World Wide Web.

Electronic commerce, however, does have certain technical challenges that must be overcome. For example, the exchange of sensitive data over a computer network requires the use of encryption protocols to protect against unauthorized access to data. Authentication or password-challenge protocols are required to ensure that the person sitting at a client computer is authorized to access certain data or an account. Given these problems and the extremely sensitive nature of the information involved, the credit reporting industry has been slow to offer its services to consumers over an open computer network. For example, credit reporting bureaus have been reluctant to deliver credit reports on-line due to the inability to adequately verify that the person sitting at a given client computer is the person identified in the credit report. In light of the above, a need exists for methods and systems that facilitate the on-line delivery of credit and financial related services, such as credit reporting and advising services. In addition, the ability to adequately authenticate users opens many possibilities for the provision of services related to credit report data, as discussed below.

### SUMMARY OF THE INVENTION

The present invention provides methods and apparatuses relating to the provision of credit and financial services. In one embodiment, the present invention provides user authentication protocols facilitating the electronic delivery of credit reports over a computer network directly to users. According to one embodiment of the invention, a credit report comprises a particular user's credit history and other financial information, and/or a credit rating. Other embodiments of the present invention allow for the provision of services related to consumer and business credit report data. In one embodiment, the present invention also allows for the merging and presentation of credit report data received from a plurality of credit reporting bureaus. In other embodiments, the present invention further provides services relating to consumer and/or business credit information. In one embodiment, the present invention facilitates correction of inaccuracies in credit report data. In another embodiment, the present invention provides monitoring services allowing users to track changes in their credit histories.

### DESCRIPTION OF THE DRAWINGS

FIG. 1 is a functional block diagram illustrating an embodiment of the present invention.

FIG. 2 is a functional block diagram illustrating the flow of data involved in one embodiment of the present invention.

FIG. 3 is a flow-chart diagram illustrating a method according to the present invention.

FIG. 4 is a flow-chart diagram setting forth a method, according to one embodiment, allowing a first-time user to register for a credit monitoring service.

FIG. 5 is a flow-chart diagram showing a method, according to one embodiment, allowing an existing user to register for a credit monitoring service.

FIG. 6 is a flow-chart diagram illustrating a method for monitoring changes in a user's credit information.

FIG. 7 is a flow-chart diagram demonstrating the operation of a credit difference engine according to one embodiment of the present invention.

FIGS. 8A through 8Q illustrate a common format, according to one embodiment, used to merge credit reports and also sets forth the categories and types of data involved in a merged credit report according to one embodiment of the present invention.

FIG. 9 is a flow-chart diagram illustrating a method for merging credit report data among a plurality of credit reports.

FIG. 10 is a flow-chart diagram setting forth a method allowing a user to correct credit report data.

FIGS. 11A-11C illustrate a credit report formatted in a user interface that facilitates correction of inaccuracies in the credit report.

FIG. 12 is a flow-chart diagram illustrating the application flow involved in one embodiment of the Credit Analyst services of the present invention.

FIGS. 13A through 13G set forth an application interface corresponding to one embodiment of the Credit Advisor services of the present invention.

FIG. 14 is a flow-chart diagram showing a method for providing credit advising services according to the present invention.

FIG. 15 is a flow chart diagram illustrating the partition of records according to one embodiment of the present invention.

FIG. 16 is a flow chart diagram illustrating a method involving application of the exclusion function.

FIG. 17 is a flow chart diagram setting forth a method allowing for the tracking of disputes related to a user's credit history.

### DESCRIPTION OF PREFERRED EMBODIMENTS OF THE INVENTION

### I. Operating Environment

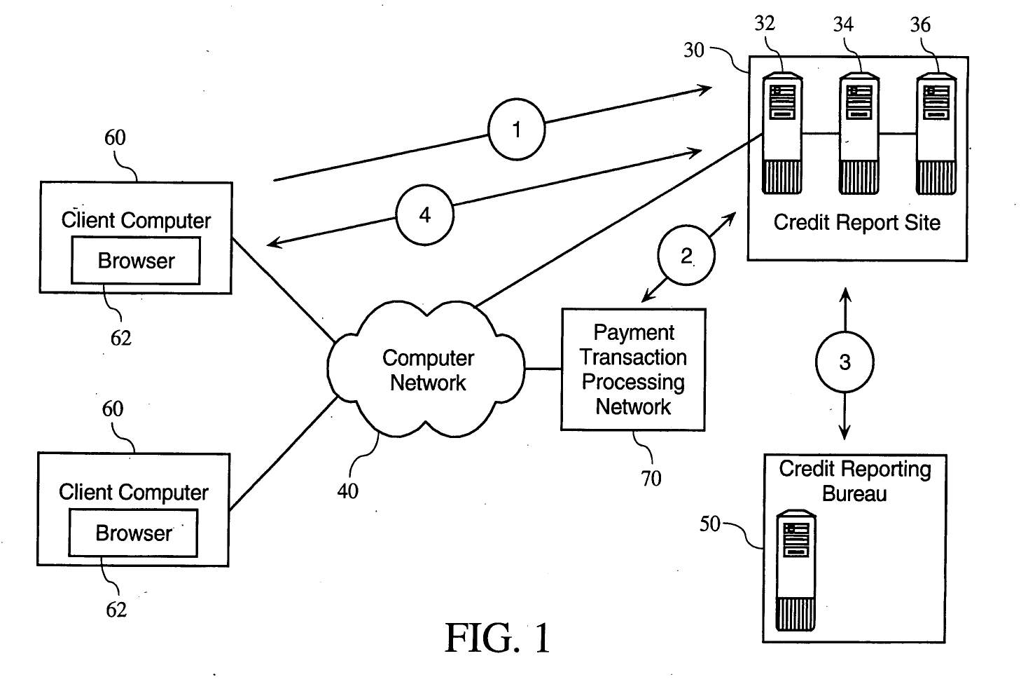

FIG. 1 illustrates an embodiment of the present invention as applied to computer network 40. Computer network 40 can be any suitable computer network, including an open, wide-area network, such as the Internet. In addition, computer network 40 can comprise an electronic network, an optical network, a wireless network, and/or a combination thereof. As FIG. 1 shows, one embodiment of the present invention operates in a computer network environment comprising credit report site 30, at least one credit reporting bureau 50, and at least one network access device, such as user computer 60. In one embodiment, the computer network environment also includes payment transaction processing network 70.

Credit Report Site 30

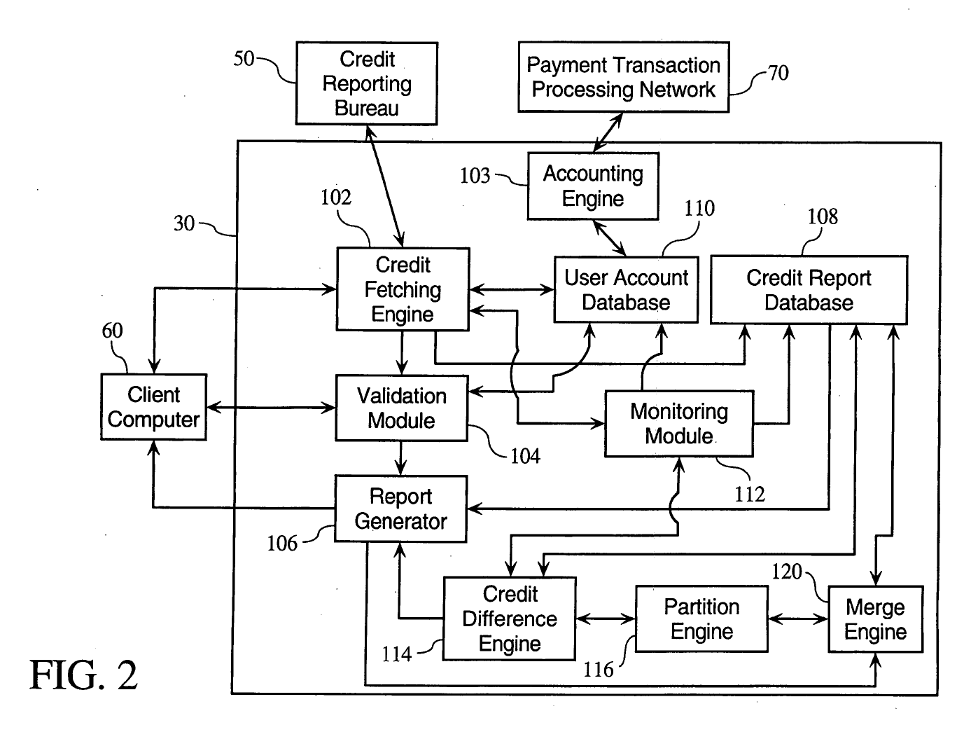

Credit report site 30 offers credit- and financial-related services to users, such as the on-line delivery of personal and/or business credit reports. In one embodiment, credit report site 30 is a web site comprising web server 32. application server 34 and database server 36. Web server 32 receives requests by users over computer network 40 and passes them to application server 34. In one embodiment, web server 32 transmits credit reports and other confidential information to users using the SSL (“Secure Sockets Layer”) encryption protocol, the S-HTTP (“Secure HTTP”) protocol, or any other similar protocol for transmitting confidential or private information over an open computer network. In one embodiment, database server 36 stores content and other data relating to the operation of the web site. In one embodiment, database server 36 includes credit report database 108 and user account database 110 (see FIG. 2). Application server 34, according to one embodiment, accesses database server 36 and generates pages that web server 32 transmits over computer network 40 to client computer 60.

In one embodiment, application server 34 includes credit fetching engine 102, accounting module 103, validation module 104, report generator 106, and monitoring module 112 (see FIG. 2). Credit fetching engine 102 interacts with the credit reporting bureaus 50 to retrieve credit reports. Accounting module 103 transmits and receives data over transaction processing network 70, as required to perform address verifications, authorize and settle transactions involving methods of non-cash payment provided by users.

Report generator 106 receives credit report data (either in single credit format or merged form) and assembles it for display and transmission. Validation module 104 executes the user authentication protocols described below. Monitoring module 112 allows users to monitor changes in credit history and executes the credit monitoring protocols described below.

Credit Reporting Bureau 50

Credit reporting bureau 50, in one embodiment, is a provider of consumer and/or business credit rating and other finance-related information. According to one embodiment of the present invention, credit reporting bureau 50 generates and sends to credit report site 30 reports relating to credit, credit rating and other finance-related information concerning individual consumers or businesses. In one form, credit reporting bureau 50 transmits such reports in electronic form over computer network 40 to credit report site 30. In another embodiment, credit reporting bureau 50 transmits such reports to credit report site 30 over a dedicated line (not shown). In addition, any method for delivering reports to credit report site 30 can be used, such as delivering reports in digital form stored on a computer-readable medium, such as a CD-ROM or diskette. In one embodiment, credit report site 30 and credit reporting bureau 50 are separate commercial entities. However, the methods and functionality of credit report site 30, in some embodiments, can be incorporated into the protocols and functionality of credit reporting bureau 50. In addition, while FIG. 1 shows one credit reporting bureau, embodiments of the present invention operate in cooperation with a plurality of credit reporting bureaus, such as EXPERIAN®, EQUIFAX®, and TRANSUNION®.

User Computer 60

Users access credit report site 30 with a network access device, which receives, displays and transmits data over a computer network. In one embodiment, a network access device is a browser executed on a personal computer, a browser executed on a network computer, a browser on a cell phone or personal digital assistant, or a voice response unit on a telephone.

One embodiment of present invention is implemented using page-based interfaces transmitted to user computer 60 having a browser 62 and a connection to computer network 40. User computer 60 can be any computer, special-purpose computing device, or any other suitable device for performing the required functionality. In one embodiment, user computer 60 includes at least one processor, a data storage system (including volatile and non-volatile media), a keyboard, a display, at least one input device and at least one output device. In one embodiment, the user's computer is connected to the Internet via a modem dial-up connection or through a network line. Such communication, however, could also be wireless. In addition, although embodiments of the system are described as working in conjunction with a browser, any suitable device or application for receiving, displaying and transmitting data over a computer network can be used in the present invention. In one embodiment, the browser 62 implemented on client computer 60 supports the SSL (“Secure Sockets Layer”) protocol, the S-HTTP (“Secure HTTP”) protocol, or any other similar protocol for transmitting confidential or private information over an open computer network.

Payment Transaction Processing Network 70

Payment transaction processing network 70, according to one embodiment, is a credit card or debit card transaction processing network, such as VISA®, MASTERCARD®, DISCOVER®, or AMERICAN EXPRESS®. In one embodiment, transaction processing network 70 enables users, at client computers 60, to provide a non-cash method of payment to credit reporting site 30. As discussed below, credit report site 30, in one embodiment, incorporates the authorization of transactions involving the non-cash method of payment provided by the user into the protocols relating to the on-line delivery of credit reports provided by credit report bureau 50. In addition, although FIG. 1 shows transaction processing network 70 as connected to computer network 40, communication of data between credit report site 30 and transaction processing network 70 can occur over a separate, dedicated network or communication line. Moreover, although FIG. 1 shows only one transaction processing network, other embodiments of the present invention operate in connection with a plurality of payment transaction processing networks, such as the VISA®, MASTERCARD®, DISCOVER®, and/or AMERICAN EXPRESS® transaction processing networks. In addition, other transaction processing networks can be incorporated such as the Automated Clearing House (ACH) network.

### II. Operation

A. On-Line Delivery of Credit Reports and Authentication of Users

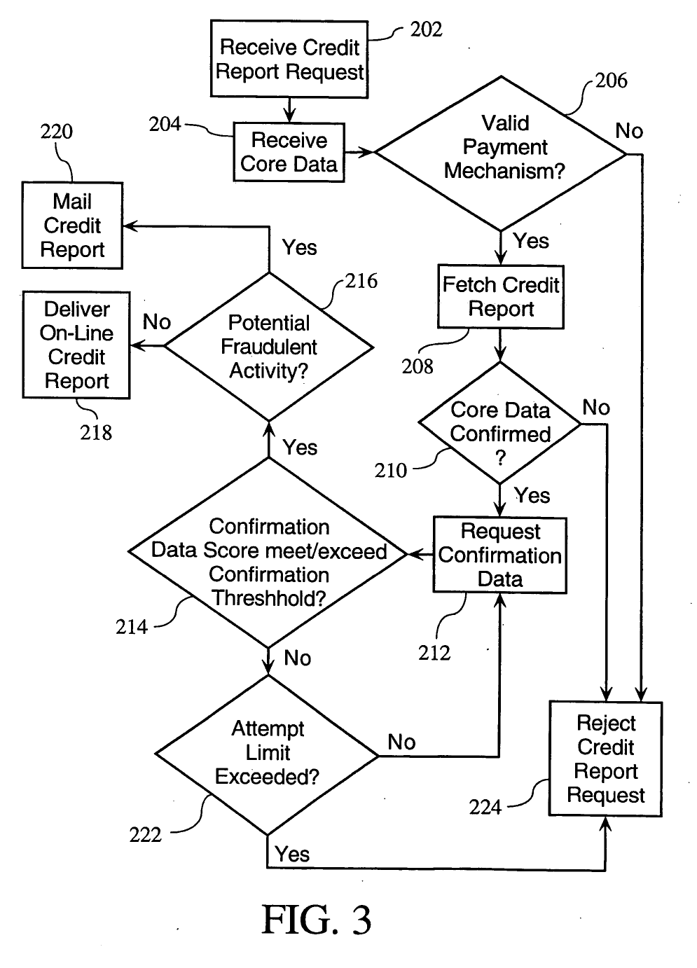

Embodiments of the present invention allow for the authentication of users and the electronic delivery of credit reports over a computer network to individual users. FIG. 3 illustrates a method according to an embodiment of the present invention, involving an extended user authentication protocol and the on-line delivery of a credit report to a user.

In one embodiment, a user, at client computer 60, accesses credit report site 30 using browser 62 to initiate the process for obtaining a credit report (FIG. 3, step 202). In one embodiment, authentication of users entails a two-phase process. In the first phase, validation module 104 prompts users for and receives core data sufficient to identify the user for the purposes of retrieving a credit report (step 204). In one embodiment, such core data comprises the user's full name and social security number. In one embodiment, core data further comprises a credit or debit card account number and an expiration date. Core data, in other embodiments, can further include address information. In one embodiment, credit report site 30 uses the credit account information provided by the user to ultimately obtain payment for delivery of a credit report to the user. In a preferred embodiment, credit report site 30 obtains a credit validation or authorization using the payment information provided by the user before fetching a credit report. In one such embodiment, accounting engine 103 accesses the payment transaction network 70 appropriate to the type of credit or debit card account provided by the user to obtain a transaction authorization for the amount charged by credit report site 30 for delivery of a credit report (step 206). In one embodiment, accounting engine 103 transmits the address information provided by the user and obtains a limited address validation from transaction processing network 70 as part of the response to the authorization request. As FIG. 3 shows, accounting engine 103, in an alternative preferred embodiment, validates the users credit card account by transmitting a validation request on the appropriate transaction processing network. If the user specifies an invalid payment method or a negative response to an authorization request is received, credit report site 30 rejects the credit report request and transmits notification of such rejection to the user (FIG. 3, step 224).

Upon receipt of a positive authorization or validation from transaction processing network, credit report site 30 obtains a credit report from at least one credit reporting bureau 50 (step 208). In one embodiment, credit report site 30 allows users the option to receive credit reports from one to a plurality of different credit reporting bureaus. In one form, credit fetching module 102 accesses credit reporting bureau 50 to obtain a credit report. In one such embodiment, credit fetching module 102 transmits the core data or a portion thereof received from the user to credit reporting bureau 50. Credit reporting bureau 50 accesses its records and returns a report to credit report site 30. In one embodiment, the credit report is stored in credit report database 108. In one form, the credit report is stored in credit report database 108 for a predetermined amount of time, such as a week or a month. Accordingly, the credit report need not be obtained again in the situation where the user's session is abnormally terminated.

Validation module 104, in one embodiment, performs an initial validation by comparing the data in the received credit report to the core data specified by the user (step 210). In one embodiment, the core data provided by the user suffices to allow for a determination that the credit report received from credit reporting bureau 50 belongs to the person identified by the core data. However, such core data in one embodiment, does not allow for a determination that the user at client computer 60 is the person identified in the credit report. If the core data provided by the user bears a sufficient correspondence to the data in the credit report, validation module 104, in the second user authentication phase, requests confirmation data to authenticate the user (step 212). If the core data provided by the user does not correspond sufficiently to the credit report data, validation module 104, as above, rejects the credit report request and transmits notification of such rejection to the user (FIG. 3, step 224).

As discussed above, validation module 104, upon positive confirmation of the core data provided by the user (step 210), requests confirmation data from the user in order to authenticate the user at client computer 60. In one embodiment, gathering of confirmation data comprises a two-phase process. In a first phase, credit report site 30 queries the user as to the types of credit, financial, and personal information he or she presently has accessible or available (e.g., such as a credit card statement, auto loan coupon, etc.). In a second phase, credit report site 30 transmits questions to the user about information in the credit report that he or she has the apparent ability to answer based upon the types of information specified by the user in the first phase. For example, if the user specifies in the first phase that she has an auto loan coupon presently available, credit report site 30 asks the user for the loan number. In another embodiment, credit report site also asks for the bank name.

As FIG. 3 shows, validation module, in one embodiment, compares the confirmation data provided by the user against corresponding credit report data to authenticate the user (step 214). In one embodiment, validation module rates or scores the correspondence between the confirmation data and credit report data. In one form, a user is deemed authenticate, if the score or rating exceeds a threshold value. In one embodiment, if the confirmation data score exceeds a threshold value, validation module 104 runs a check for potential fraudulent activity (FIG. 3, step 216). For example, credit reports provided by many credit reporting bureaus include an indication as to the potential for fraudulent activity. An example is EXPERIAN's® File Address Check Service (FACS) providing a fast access service for identifying potential credit fraud. According to this example, validation module 104 scans the credit report for an indication as to the potential for fraudulent activity. If a sufficient potential for fraudulent activity exits, credit report site 30, in one embodiment, mails the credit report to the address identified in the credit report data and notifies the user accordingly (step 220). Otherwise, credit report site 30 delivers the credit report electronically over computer network 40 (step 218). If the confirmation data score lies below the threshold value, the user, in one form, is given a limited number of opportunities to resubmit confirmation data (FIG. 3, step 222). In one embodiment, confirmation data can be any data contained in the credit report received from credit reporting bureau 50. For example, types of confirmation data include, but are not limited to, present employer, previous employer, date of birth, previous address, installment account numbers (such as an auto or home loans), and revolving account number (such as credit card accounts).

To expedite the validation process, one embodiment of validation module 104, based upon the types of credit and financial information specified by the user in the first phase, computes the number and types of questions (i.e., the types of confirmation data), if answered correctly, would exceed the threshold value sufficient to authenticate the user. If the user answers the questions sufficiently, the user is deemed authenticate. Otherwise, user validation module 104 transmits more questions relating to confirmation data to the user.

In one embodiment, users establish an account with credit report site 30. In one embodiment, users provide an account identification and a password, which are stored in user account database 110. In one form, after a user establishes such an account and is authenticated according to the methods described above, he need only log into credit report site 30 and provide a password for authentication purposes.

In one embodiment, if a user is unable to properly authenticate himself on-line, credit report site 30 mails out a form including a tracking identification to the address indicated on the credit report. Subsequently, the user may login and provide a password associated with the user account and the tracking identification supplied in the form and receive the credit report electronically.

1. Validation of User-Provided Data

In one embodiment, validation module 104 rates or scores the level of correspondence between the core and confirmation data provided by the user and the credit report data received from credit reporting bureau 50. According to this embodiment, individual or entity identified by the core data provided by the user is deemed to belong to the credit report, if the score or rating the core data receives exceeds or meets a threshold value. For example and in one embodiment, core data includes the following fields: 1) full name and 2) social security number. In another embodiment, core data further comprises 3) current address and 4) a credit card account number. Similarly, a user is deemed authentic, if the confirmation data score exceeds or meets a threshold value.

a. Match Ratings

In one embodiment, validation module 104 applies a set of rules to determine and rate a match for each element of core data and/or confirmation data provided by the user. In one form, the score for each element of core data is aggregated and compared against a threshold value to determine whether the core data provided by the user sufficiently corresponds to the credit report data. In one form, validation module 104, when matching strings of letters such as names and addresses, uses the longest common subsequence to determine degrees of matching. In one embodiment, the longest common subsequence is found by first removing punctuation and spaces, and then converting all characters in each string to lower case characters, if applicable. Validation module 104 then finds the longest sequence of characters that appear in both strings. For example, the longest common subsequence for the names Laurie and Lorrie is l-r-i-e, obtained from l-a-u-r-i-e and l-o-r-r-i-e. (See Section II.B.1.a.1), infra, for a more detailed discussion of the longest common subsequence).

In one embodiment, an exact match requires that the strings be identical after removing spaces and punctuation. A partial match, in one embodiment, is deemed a sufficient partial match if the number of characters in the longest common subsequence is equal to or greater than ⅔ of the number of characters in the corresponding field in the credit report data. In one embodiment, an exact match and a sufficient partial match corresponds to a match rating of 1.0. while an insufficient match receives a match rating of 0.0. Table 1 illustrates an embodiment of the match ratings for didactic purposes. Of course, the specific match rating values, threshold values and threshold sequence lengths described herein are not critical to the invention and may vary significantly. For example, a full match, in another embodiment, may be assigned a match rating of 10 points, while a partial match receives 8 points.

TABLE 1

| Data Provided | Credit Report Data | Match Type | Match Rating |
|---|---|---|---|
| Jonathon | Jonathon | Full Match | 1.0 |
| Jonathon | Jonathan | Partial Match | 0.5 |
| Jonathon | Junior | No Match | 0 |
| Jonathon | <blank> | No Match | 0 |

b. Matching Rules Specific to Types of Data

In one embodiment, validation module 104 applies matching rules that are specific to certain types of data.

1) Personal Names

In one embodiment, validation module 104, when rating a match for personal names, determines a match rating, individually, for the first, middle and last names and averages the resulting ratings to derive an aggregate match rating. In one embodiment, validation module 104, using the longest common subsequence, determines the degree of matching for first, middle, and last names. In one embodiment, a full match receives a match rating of 1.0, while a partial match receives a match rating of 0.5. The match rating for the full personal name, in one embodiment, is the sum of the name element ratings divided by the number of elements. For example and according to the embodiment described above, the full personal names “Jonathon Quincy Consumer” and “Jon Quincy Consumar” receive a match rating of 0.5[(0+1.0+0.5)/3].

2) Social Security Number

Validation module 104, in one embodiment, uses the longest common subsequence in determining a match for social security numbers. For example and in one embodiment, if the length of the longest common subsequence is greater than or equal to 8 characters, then the partial match is deemed sufficient and receives a match rating of 1.0. Of course, a full match also receives a match rating of 1.0. The actual threshold number of characters for a sufficient match depends on the level of certainty required by the application.

3) Account Numbers

In one embodiment, account numbers that partially match will be deemed a sufficient partial match and receive a match rating of 1.0, if the length of the longest common subsequence is greater than 80% of the length of the sequence length of the account number contained in the credit report data.

4) Address

In one embodiment, validation module 104 individually rates a match for each corresponding address component in the data provided by the user and the credit report data. In one form, the match rating for the address is the lowest value among the resulting ratings. A partial match, in one embodiment, is deemed a sufficient partial match if the number of characters in the longest common subsequence is equal to or greater than ⅔ of the number of characters in the corresponding address component in the credit report data. In one embodiment, certain components of the address such as “State” require a full match in order to receive a match rating of 1.0. Table 2 illustrates one embodiment:

TABLE 2

| | Full Match | Partial Match | No Match |
|---|---|---|---|
| Address Component | Score | Score | Score |
| Street Number | 1.0 | 0.5 | 0 |
| Street Name | 1.0 | 1.0 | 0 |
| City | 1.0 | 1.0 | 0 |
| State | 1.0 | 0 | 0 |

In one example, if a user supplies an address of “940 Tiverton Ave, Los Angeles, Calif.” and the corresponding credit report data is “90 Tiverton Ave, Los Ange, Calif.”, then the match rating is 0.5 [the minimum of (0.5, 1.0, 1.0, and 1.0)].

c. Validation of Core Data

In one embodiment, validation module 104 calculates an aggregate or overall score for the core data provided by the user. In one embodiment, validation module 104 calculates a weighted aggregate score. In one embodiment, each element of core data received from the user contributes equally to the weighted aggregate score. For example, and in one embodiment, validation module 104 multiplies the match rating calculated as described above by a weighting value of 25. In one embodiment, an aggregate score is achieved by summing the weighted match ratings for each element of core data. In one embodiment, if the resulting score for the core data exceeds or meets a threshold value (e.g., 35 points), then the credit report is deemed to belong to the individual or entity identified by the core data.

d. Confirmation Data Validation

In one embodiment, validation module calculates a confirmation data score from the entire set of confirmation data provided by the user. In one embodiment, each element of confirmation data possesses a relative worth as it relates to the level of certainty about a user's identity an exact or partial match provides. In one embodiment, relative worth is reflected in the weighting value that a particular element of confirmation data is accorded. Table 3 illustrates the confirmation data elements and associated weighting values that are used in one embodiment of the present invention.

TABLE 3

| Confirmation Data Element | Weighting Value |
|---|---|
| Current Address | 25 |
| Revolving Account Number | 25 |
| Date of Birth | 50 |
| Employer Name | 50 |
| Previous Address | 50 |
| Installment Account Number | 100 |

In one embodiment, the confirmation data score is the weighted sum of match ratings computed for each element of confirmation data. As with core data, if the confirmation data score meets or exceeds a threshold value, the user is deemed authentic.
B. Merged Credit Reports

Credit report site 30, in one embodiment, offers the users the option to receive credit reports from a plurality of credit reporting bureaus. In one form, credit report site 30 merges the data from a plurality of different credit reports into a single merged report. In one embodiment, credit report site 30 merges data from credit reports belonging to two or more users (e.g., husband and wife). For example and in one embodiment, credit report site 30 merges data from six credit reports received from three credit reporting bureaus for two individuals and generates a merged credit report.

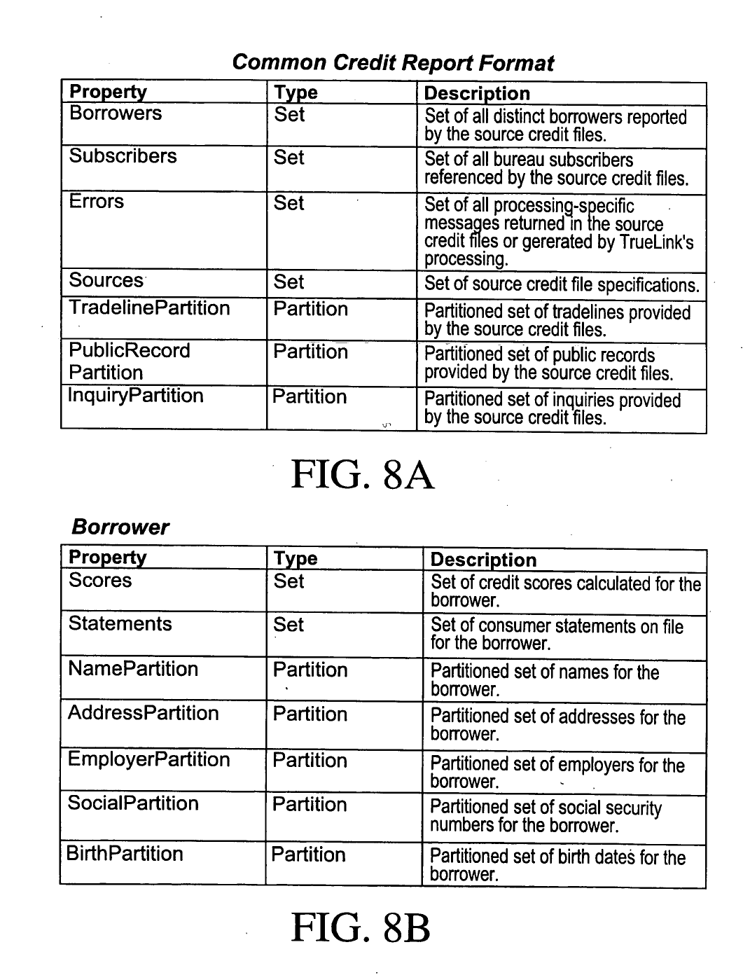

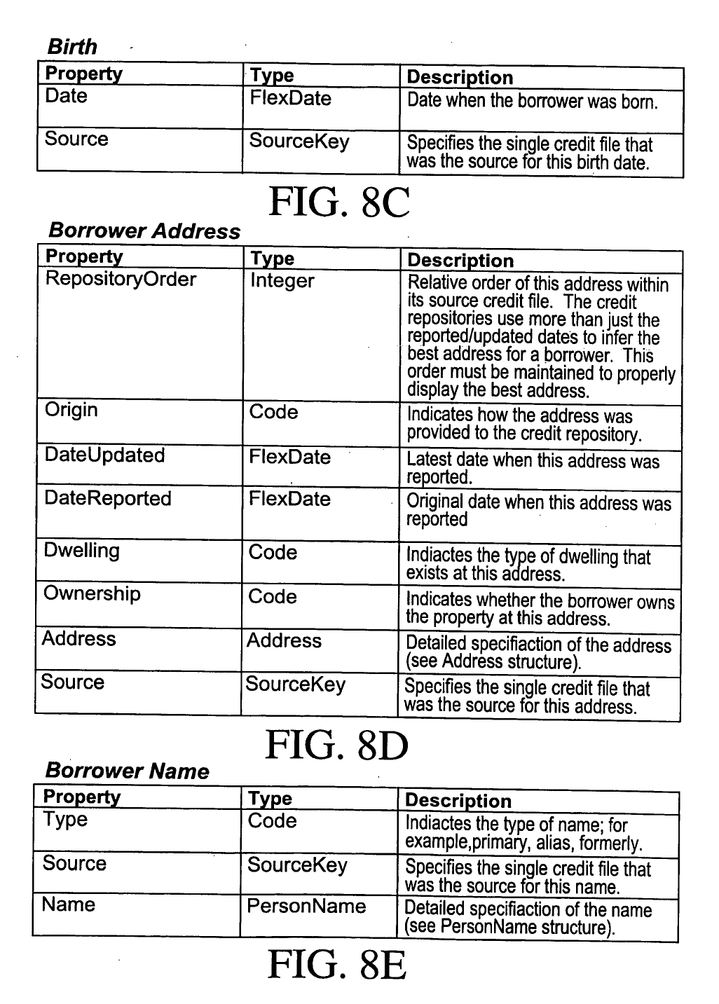

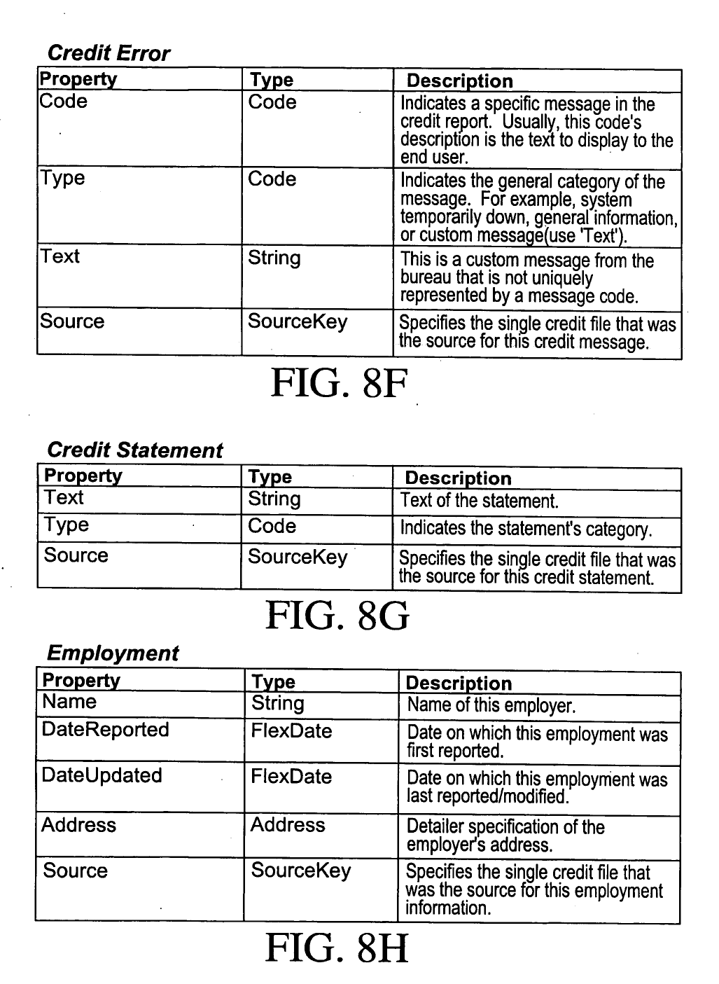

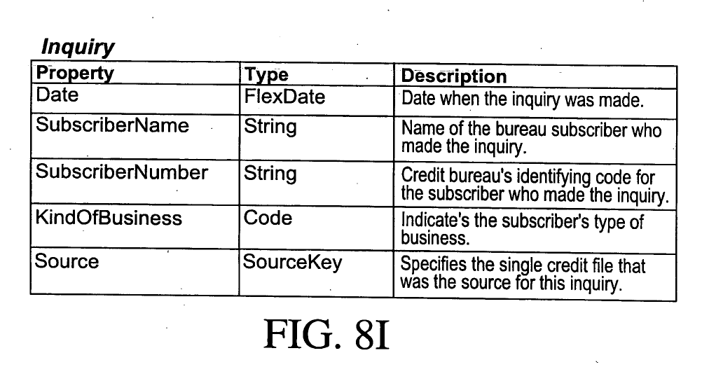

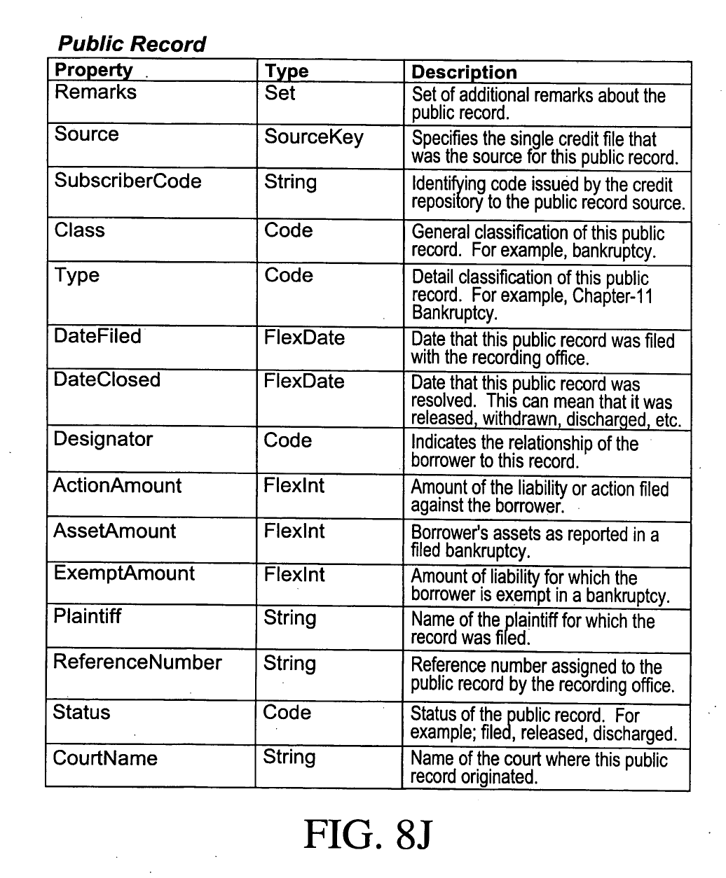

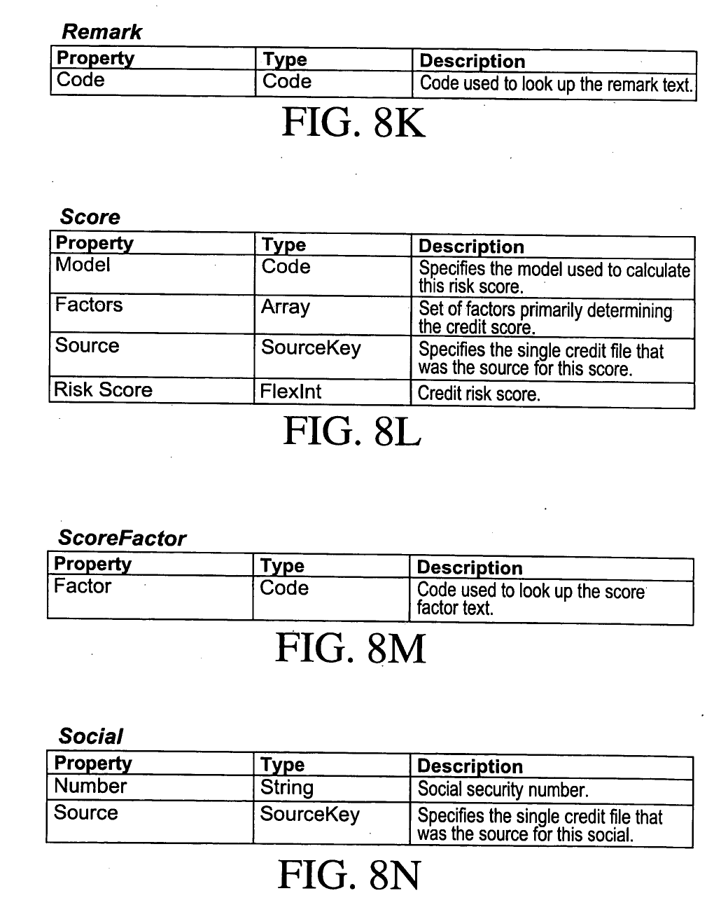

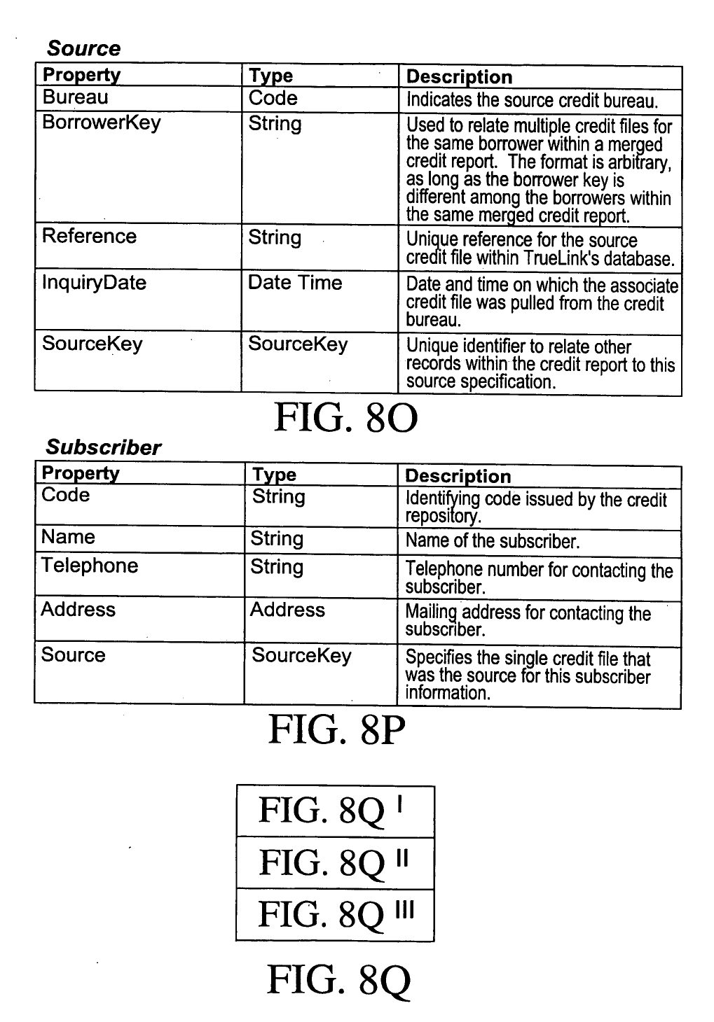

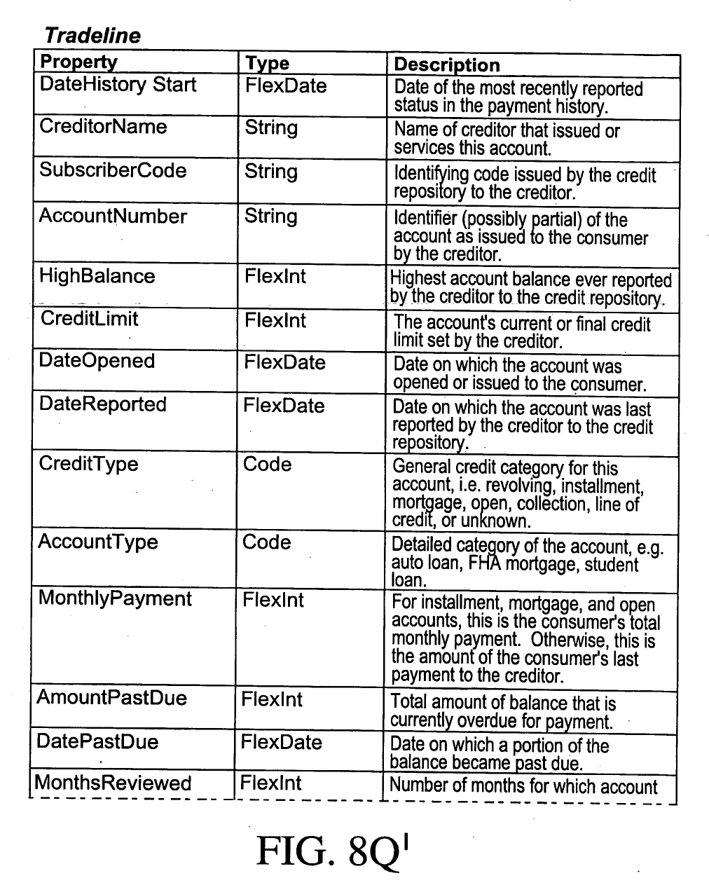

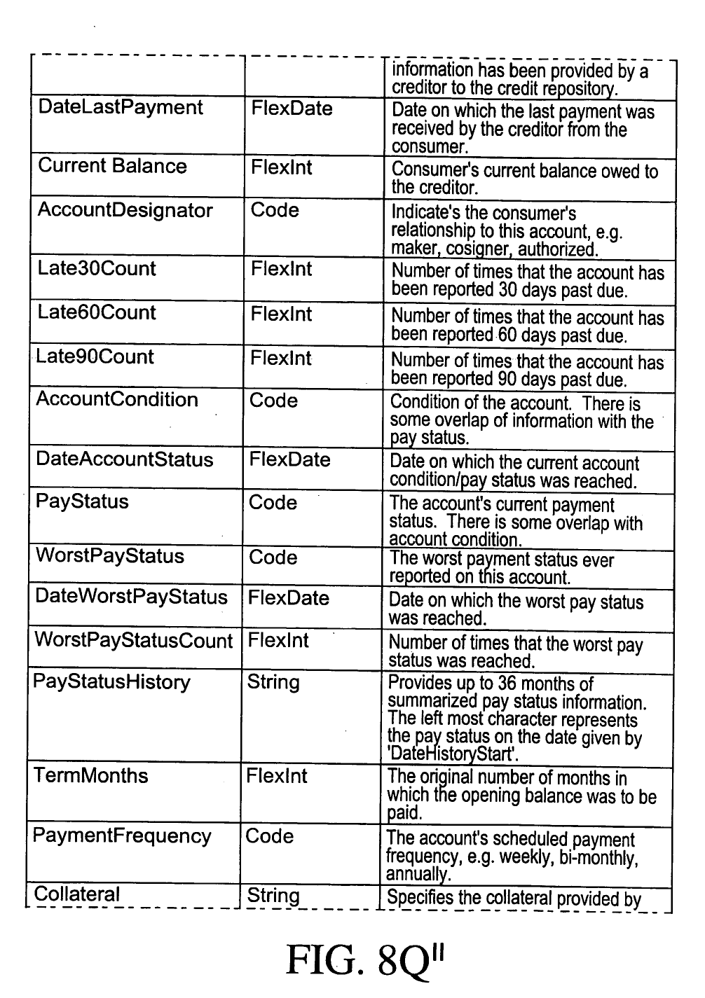

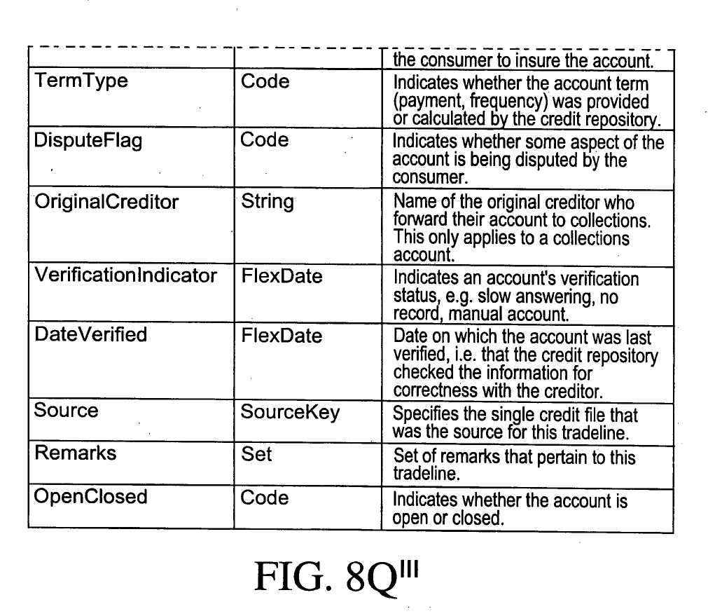

Since single credit data (data for a single user from a single credit reporting bureau) from two different sources for the same individual will usually contain much identical data, the merge process, in one embodiment, prevents duplication of data in the resulting merged credit report transmitted to the user. In addition, although all single credit data for a user represents his financial history, each credit reporting bureau's representation (format) is usually unique. In one embodiment, a common format is used to simplify the process of combining together different models of the same user's credit data. FIGS. 8A through 8Q provide an embodiment of a common format for each section of common credit report data. In one embodiment, the credit report data received from the credit reporting bureaus is converted into a common format before the merging process, described below, is implemented.

In one embodiment, the process of merging credit report data into a common or merged format involves partitioning records into sets of equivalent records and selecting the best representative record from each set or partition. In one embodiment, the operation of partitioning records into sets of equivalent records is based on a series of rules. In one embodiment, the partitioning rules comprises a set of rules for determining equivalence of records across credit reports. In one embodiment, partitioning of records among credit report data operates on a category-by-category basis, wherein the particular data category determines the set of partitioning rules that are applied. For example, credit reports usually include the following categories: 1) tradeline information (financial account information, such as mortgages, credit card accounts, etc), 2) public record information (e.g., bankruptcies, foreclosures, tax liens, etc.), and 3) inquiries (e.g., credit inquiry from a lending institution). In this example, the rules applied to determine whether two records are equivalent depend on whether such records fit into the tradeline, public record, or inquiry category.

FIGS. 8A through 8Q illustrate the credit report data categories and types of data included in a merged credit report according to one embodiment of the present invention. For didactic purposes, only the merging of tradeline, public record and inquiry sections of a credit report is described. The merging of other categories, however, is, in one embodiment, based upon the same general principles described herein. In one embodiment, the borrower names and addresses are ignored. In one embodiment, the credit rating scores (e.g., FICO scores) for all single credit data will be stored and returned along with the merged credit data after the merge process has completed. Therefore, it is possible that a merge credit data will contain up to 6 credit rating scores (3 for each of the 2 borrowers in this example).

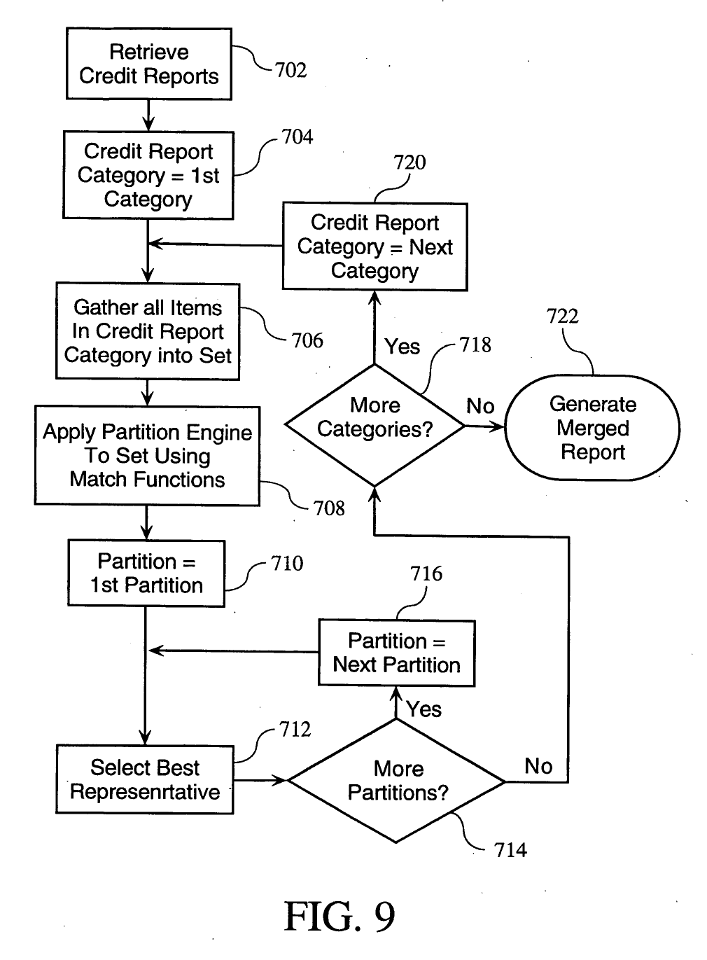

FIG. 9 illustrates one embodiment of the process for generating a merged credit report from at least two credit reports. Merge engine 120 retrieves data from at least two credit reports stored in credit report database 108 (step 702). In one form, the credit reports were fetched during the user's session by credit fetching engine 102 in response to a request from a user to fetch current credit reports from at least two credit reporting bureaus. In another embodiment, merge engine 120 retrieves credit reports previously stored in credit report database 108. As FIG. 9 illustrates, one embodiment of merge engine 120 operates on a category-by-category basis in partitioning and eventually merging credit report data. In one embodiment, merge engine 120, starting with the first credit report category (step 704), assembles all items or records corresponding to the current category among the credit reports into a set of records (step 706). In one embodiment, merge engine 120 invokes partition module 116 to segregate the items or records in the data set into various partitions. A single partition, in one embodiment, represents a real-world element of the credit history or information, such as a home loan or credit card account. In other words, partition module 116 operates such that each item or record in the data set is grouped with all other equivalent items or records that represent the same real-world element of credit history or information. In one embodiment, partition module 116 applies a set of rules-based functions to segregate or partition the items or records in the data set (see Section II.B.1, infra).

After the data set is partitioned, merge engine 120, starting with the first partition (step 710), operates to merge the data corresponding to the current partition. In one embodiment, merge engine 120 applies a set of rules-based functions to select the best representative from among the items or records in the current partition (step 712). (See Section II.B.2., infra). In another embodiment, merge engine 120 scans the data in the current partition set and retrieves that data that is more accurate, more informative, or both more accurate and more informative. In another embodiment, merge engine 120 packages the data in the records of the current partition together so that analysis on the credit history item has access to all the constituent data from each credit reporting bureau. This process is repeated for every partition in the current category (see FIG. 9, steps 714 and 716). Merge engine 120 then proceeds to the next report category (steps 718 and 720) performing the steps provided above. In one embodiment, the rules for partitioning and merging data vary across credit report categories (see below). Upon exhaustion of all categories (step 718), merge engine 120 generates a merged report (step 722).

1. Partition Engine and Partitioning of Data

In one embodiment, partitioning is: based on an equivalence function, f_{E}(sᵢ, sⱼ), which returns a true value to indicate whether two records should be considered equivalent. In another embodiment, partitioning of records is based on an equivalence function and an exclusion function.

The equivalence relationship [E(x, y)] is reflexive; in other words, all records are equivalent to themselves [E(x, x)]. The equivalence relationship is symmetric (i.e., E(x, y)→E(y, x)). In addition, the equivalence relationship is transitive; in other words, E(x, y)ΛE(y, z)→E(x, z). As discussed below, the equivalence function, in one embodiment, comprises a plurality of supporting functions.

For didactic purposes, S_{r,b} represents the data for a given category in a single credit report for credit reporting bureau, r, and entity or user, b. The data set, S, upon which partition engine 120 operates is defined by

$$S = {⋃}_{r , b} {S}_{r , b} \qquad ( 1 )$$

where r varies over the set of credit reporting bureaus and b varies over the set of entities or users to contain the set of all data in a given credit report category from all credit reports retrieved from the relevant credit reporting bureaus. In addition, P₁-P_{N} represent the partitioning of the data set, S, such that

$${{⋃}_{n = 1}}^{N} {P}_{n} = S ( they cover the record set ) and \\ {∀}_{k \neq l} {P}_{k} ⋂ {P}_{l} = Ø ( they are disjoint ) . \qquad ( 2 )$$

### ILLUSTRATIVE EXAMPLE

Let the following credit report data, S_{r,b}, represent the tradelines among the credit reports for three credit reporting bureaus, EXP, TUC, and EQF for a single user:
S_{EXP,1}={s1,s4,s6}
S_{TUC,1}={s2, s5, s7}
S_{EQF,1}={s3, s8} (3)
The data set, S, for the tradeline category, therefore, is
S={s1, s2, s3, s4, s5, s6, s7, s8} (4)

The following matrix provided by Table 4 shows the pairs of records or items, sₙ, for which the equivalence function, f(s_{i, s}ⱼ), returns a true value. Entries having a “T” indicate the record or item pairs for which equivalence exists. Entries having a “+” indicate equivalence relationships derived through the transitive nature of the equivalence function.

TABLE 4

| | s₁ | s₂ | s₃ | s₄ | s₅ | s₆ | s₇ | s₈ |
|---|---|---|---|---|---|---|---|---|
| s₁ | T | T | + | | | | | |
| s₂ | T | T | T | | | | | |
| s₃ | + | T | T | | | | | |
| s₄ | | | | T | T | | | |
| s₅ | | | | T | T | | | |
| s₆ | | | | | | T | + | T |
| s₇ | | | | | | + | T | T |
| s₈ | | | | | | T | T | T |

Partitions, in one embodiment, are defined by the records or items whose equivalence relationships define a group. For the example of Table 4, the partitions are:
P₁={s1,s2,s3}
P₂={s4,s5}
P₃={s6,s7,s8 } (5)

a. Supporting Functions and the Equivalence Function

In one embodiment, a plurality of supporting functions define, in part, the equivalence relationship. In one embodiment, the supporting functions operate on individual elements (e.g., date, lender name, account number, etc.) of the items or records in the credit report data. In one form, the particular set of supporting functions defining the equivalence relationship depends on the credit report data category. For example, the supporting functions defining equivalence for the tradeline category, in one embodiment, differ from the supporting functions for the public records category. The following provides an illustrative example of supporting functions for the tradeline, public records, and inquiries categories according to one embodiment.

1) Supporting Functions

In one embodiment, partitioning engine 116 computes the longest common subsequence in evaluating the correspondence between two strings of data. For example, given a sequence X={x₁, x₂ . . . xₙ}, another sequence Z={z₁, z₂ . . . zₖ} is a subsequence of X, if there exists a strictly increasing sequence {i₁, i₂ . . . iₖ} of indices of X such that for all j=1, 2, . . . k, xᵢⱼ=zⱼ. For example, Z={B,C,D,B} is a subsequence of X={A,B,C,B,D,A,B} with a corresponding index sequence {2,3,5,7 }. Given two sequences, X and Y, a sequence Z is deemed a common subsequence if Z is a subsequence of both X and Y. The longest common subsequence of two sequences, X and Y, is the longest of all possible common subsequences between X and Y. Table 5 provides examples of string pairs and their corresponding Longest Common Subsequences (LCSs) according to one embodiment of the present invention.

TABLE 5

| s₁ | s₂ | LCS(s₁, s₂) |
|---|---|---|
| 419008080306 | 08080329 | 080803 |
| 507363528138 | 507363000302 | 5073632 |
| FSTUSABK | FIRSTUSABANK | FSTUSABK |
| 7738201032651 | R50738095 | 73805 |

Moreover, in one embodiment, correspondence between two strings of data is evaluated based upon the ratio of the LCS to the length of the smaller string.

$$LCSRatio ( {s}_{1} , {s}_{2} ) = \frac{Length ( LCS ( {s}_{1} , {s}_{2} ) )}{min \{ Length ( {s}_{1} ) , Length ( {s}_{2} ) \}} \qquad ( 6 )$$

As discussed below, embodiments of the present invention use the LCSRatio (6) to determine whether two strings are a match. In addition, correspondence between two strings is evaluated based upon the ration of the LCS to the length of the larger string.

$$MinLCSRatio ( {s}_{1} , {s}_{2} ) = \frac{Length ( LCS ( {s}_{1} , {s}_{2} ) )}{max \{ Length ( {s}_{1} ) , Length ( {s}_{2} ) \}} \qquad ( 6 a )$$

As discussed below, the MinLCSRatio (6a) function, in one embodiment, supports exclusion partitioning functions.

### a) Comparing Dates

In one embodiment, partition engine 120 compares various dates in the records or items in the data set, S, in the equivalence determination. In one embodiment, the date comparison functions yield a match rating. The function CompMonth (7) determines whether the months between two given dates match. In the embodiment shown, the CompMonth and CompYear functions also address the situation where the date for an item in a credit report may not include the month or year and is, therefore, an unknown value (‘XX’). In one embodiment, the logic contained in the equivalence function allows two dates to be considered a sufficient match, if the corresponding years match, but at least one month field contains an unknown value (‘XX’).

$$\begin{matrix}CompMonth ( MM , mm ) = \{ \begin{matrix} 2 , if MM = mm and MM {}_{}^{′}{XX}{}_{}^{′} \\ 1 , if MM = {}_{}^{′}{XX}{}_{}^{′} or mm = {}_{}^{′}{XX}{}_{}^{′} \\ 0 , if otherwise\end{matrix} & ( 7 ) \\ CompYear ( YY , yy ) = \{ \begin{matrix} 2 , if YY = yy and YY \neq {}_{}^{′}{XX}{}_{}^{′} \\ 1 , if YY = {}_{}^{′}{XX}{}_{}^{′} or yy = {}_{}^{′}{XX}{}_{}^{′} \\ 0 , if otherwise\end{matrix} \\ CompDate ( YYMM , yymm ) = min \{ CompMonth ( MM , mm ) , CompYear ( YY , yy ) \} & ( 8 )\end{matrix}$$

Using the above-provided functions, partition engine 116, in one embodiment, compares date in credit report data by taking the minimum value of the CompMonth and CompYear functions. (See CompDate Function (9), above).

### b) Comparing Account Numbers

Account numbers, in one embodiment, are also compared and assigned a match rating based on the CompAcct function (10), below.

$$CompAcct ( A1 , A2 ) = \{ \begin{matrix} 3 , if A1 = A2 \\ 2 , if A1 \neq A2 and LCSRatio ( A1 , A2 ) = 1.00 \\ 1 , if 0.70 \leq LCSRatio ( A1 , A2 ) < 1.00 \\ 0 , if LCSRatio ( A1 , A2 ) < 0.70\end{matrix} \qquad ( 10 )$$

### c) High Credit Matching

In one embodiment, the high credit value depends on the credit reporting bureau and the particular account type. According to one form, high credit is either the highest balance ever maintained by the account holder or the credit limit on the account. The CompHC function (11), in the embodiment shown below, determines whether the high credit values match.

$$CompHC ( C 1 , C 2 ) = \{ \begin{matrix} 1 , if C 1 = C 2 and C 1 \neq {}_{}^{′}{XX}{}_{}^{′} \\ 0 , if C 1 \neq C 2\end{matrix} \qquad ( 11 )$$

### d) Credit Type Matching

Partition engine 116, in one embodiment, uses the function CompType (12) to provide a match rating for credit types between two account records.

$$CompType ( T 1 , T 2 ) = \{ \begin{matrix}1 , if T 1 = T 2 \\ 0 , if T 1 \neq T 2\end{matrix} \qquad ( 12 )$$

### e) Creditor Name Matching

In one embodiment, partition engine 116 uses the function CompCreditor (13) to provide a match rating between to creditor names. However, the following function has application in providing a match rating for any personal or business name.

$$CompCreditor ( Cr 1 , Cr 2 ) = \{ \begin{matrix} 3 , if Cr 1 = Cr 2 \\ 2 , if Cr 1 \neq Cr 2 and LCSRatio ( C r 1 , Cr 2 ) = 1.00 \\ 1 , if 0.70 \leq LCSRatio ( Cr 1 , Cr 2 ) < 1.00 \\ 0 , if LCSRatio ( Cr 1 , Cr 2 ) < 0.70\end{matrix} \qquad ( 13 )$$

2) Equivalence Functions

In one embodiment, an equivalence function comprises a plurality of supporting functions, such as those set forth in Sections II.B.1.a.1)(a)-(e), supra. In one embodiment, the equivalence function comprises a plurality of supporting functions and returns a boolean value based on the resulting values of the supporting functions. Of course, the equivalence functions could return a numerical equivalence rating, rather than a boolean value. The following pseudo-code provides an example of an equivalence function according to one embodiment of the present invention.

### a) Tradeline Equivalence Function

As discussed above, tradeline data, in one embodiment, includes financial and credit account data, such as a home mortgage, credit card, debit card, or checking account. As seen from the algorithm, infra, the equivalence function, fₓ(a,b), comprises, in one embodiment, a series of boolean expressions incorporating the supporting functions discussed above. For example, when comparing two items or records in a data set, S, partition engine compares, among others, the respective opening dates of the accounts, the account numbers, and creditor names.

Bool f_{E}(a,b)
{

If (a or b not collection account) {

If (CompDate(a.OpenDate,b.OpenDate) = 0)

Return false

}
If (CompAcct(a.AcctNbr,b.AcctNbr)=0)

Return false

If (CompAcct(a.AcctNbr,b.AcctNbr)=3)

Return true

If (CompAcct(a.AcctNbr,b.AcctNbr)=2 and

CompHC(a.HighCredit,b.HighCredit)=1 and
CompType(a.CreditType,b.CreditType)=1)

{

return true

}
If (CompCreditor(a.CreditorName,b.CreditorName) in {2,3})

Return true

If (CompCreditor(a.CreditorName,b.CreditorName)=0)

Return false

If (CompType(a.CreditType,b.CreditType)=1)

Return true

Return false

}

### b) Public Records Equivalence Function

In one embodiment, a different equivalence function applies to the partitioning of data in the public records category. In the embodiment shown, two items are considered equivalent, if an aggregate score based on a comparison of individual elements, such as filing date (“FilingDate”) and reference number (“RefNbr”), exceeds a threshold value.

Bool f_{E}(a,b)
{

If (a.FilingDate <> b.FilingDate)

Return false

If (LCSRatio(a.RefNbr,b.RefNbr) >= 0.8)

Return true

Else

Return false

}

### c) Inquiry Category Equivalence Function

In one embodiment, partitioning engine 116 further includes functionality to partition data sets relating to inquiries made concerning a particular user's or entity's credit report information. The following function illustrates an embodiment of a function used for partitioning items or records in a data set relating to credit inquiries.

Bool f_{B}(a,b)
{

Score = 0
If (a.Date = b.Date)

Score += 2

Else if (|a.Date − b.Date| <= 7 days)

Score += 1

If (CompCreditor(a.SubscriberName,b.SubscriberName) in {2,3})

Score += 2

Else if (CompCreditor(a.SubscriberName,b.SubscriberName) = 1)

Score += 1

If Score >= 3

Return true

Else

Return false

}

b. Optimization of Equivalence Partitioning

In one embodiment, a partition key is used to create preliminary partitions to reduce the number of pair-wise equivalence determinations and, thus, increase the efficiency of the algorithm. A partition key, in one form, is an element in a credit report item that typically must match for two items to be considered equivalent. For example, a suitable partition key for tradeline items is the open date for a particular account. Of course any suitable partition key can be used.

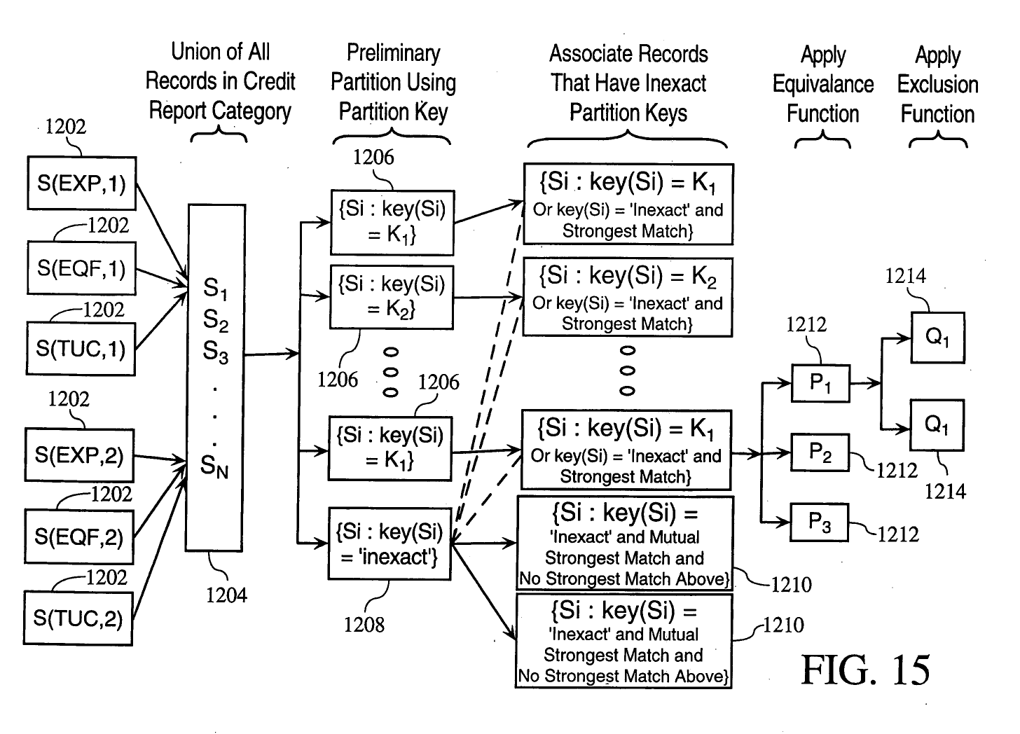

FIG. 15 illustrates the use of partition keys in the partition of data sets from six credit reports 1202 corresponding to two persons (1, 2). A partition key, key(Si), is used to create preliminary partitions 1206 of the set of records 1204 for a particular credit report category. For example, partition engine 116 extracts the open date, K_{1 (the partition key of one embodiment), from the first record, S}₁, in the set of records 1204 and groups all other records that have the same open date into the same partition 1206. In one embodiment, partition engine 116 groups all records where the value corresponding to the partition key is unknown (‘XX’) or inexact (e.g., a year is provided for the open date, but no month) into a separate partition 1208. In one embodiment, partition engine 116 then associates all records in the separate partition 1208 with partitions 1206 where the value corresponding to the partition key is known and exact. However, those records in the separate partition 1208 having no strong match to records in partitions 1206 are placed in partitions 1210 according to their mutual strongest match. As FIG. 15 shows, partition engine 116 then applies the equivalence function to the resulting preliminary partitions to yield equivalence partitions 1212. [Note: FIG. 15 shows equivalence partitions only for one preliminary partition for purposes of illustration. It is to be understood that partition engine 116, in one embodiment, operates on each preliminary partition.] As discussed more fully below, partition engine, in one embodiment, applies an exclusion function to the equivalence partitions 1212 to further partition the records into exclusion partitions 1214.

2. Exclusion Partitioning

In another embodiment, partitioning of data involves two forms of partitioning. In a first phase, records are partitioned into equivalent sets based on an equivalence function, such as the one discussed above, for further partitioning in a second phase. In the second phase, the partitioned sets are further partitioned according to an exclusion function. In one embodiment, the exclusion function indicates the relative association strength between two records, and whether two records are strictly compatible.

The equivalence functions partition the records by including records into a partition if they are similar to any record within that partition. Exclusion partitioning, on the other hand, disallows two records from being in the same partition if they are not similar enough, irrespective of that record's similarity to other records within the same partition. In contrast to the equivalence partitioning, exclusion partitioning, in one embodiment, is driven by the strength of the similarity rather than a true or false evaluation. In one embodiment, exclusion partitioning is performed on the equivalence partitions to further subdivide according to pair-wise incompatibilities.

The following describes the properties of the exclusion function according to one embodiment of the present invention. For didactic purposes, let Q₁, Q₂ , . . . Q_{N} represent a partitioning of S such that

$${{⋃}_{n = 1}}^{N} {Q}_{n} = S$$

(the partitions cover the record set),

$${∀}_{n} {∃}_{m} {Q}_{n} ⊆ {P}_{m}$$

(each exclusion partition set is a subset of one equivalence partition), and

$${∀}_{k \neq l} {Q}_{k} ⋂ {Q}_{l} = ∅$$

(each exclusion partition is disjoint). In addition, the exclusion partitions are defined by the following statement:

$${∀}_{i , j , n} [ \begin{matrix}\{ {s}_{i} , {s}_{j} \} ⊆ {Q}_{n} ⇔ E ( {s}_{i} , {s}_{j} ) ⋀ {f}_{x} ( {s}_{i} , {s}_{j} ) \geq 0 ⋀ \\ ⫬ {s}_{m} {∃}_{∈ Q n} ( \begin{matrix}max \{ {f}_{x} ( {s}_{i} , {s}_{j} ) , {f}_{x} ( {s}_{m} , {s}_{j} ) \} > {f}_{x} ( {s}_{i} , {s}_{j} ) ⋀ \\ min \{ {f}_{x} ( {s}_{i} , {s}_{m} ) , {f}_{x} ( {s}_{m} , {s}_{j} ) \} < 0\end{matrix} )\end{matrix} ] \qquad ( 14 )$$

In other words, two mutually compatible records are included in the same partition set, as long as neither of those records has a stronger compatibility with a third record (in the set) that excludes the other record. In order to guarantee that there is a partition satisfying these constraints,

$${∀}_{( i , j ) \neq ( k , l )} [ {f}_{x} ( {s}_{i} , {s}_{j} ) \geq 0 ⇒ {f}_{x} ( {s}_{i} , {s}_{j} ) \neq {f}_{x} ( {s}_{k} , {s}_{l} ) ]$$

must hold true. This may be ensured by adding a distinct small perturbing value as a function of (l,j) that guarantees uniqueness. In addition, the exclusion function should be symmetric: ƒₓ(si,sj)=ƒₓ(sj,si).

In one embodiment, the final result of the merge process is the result of the exclusion partitioning (for example, to generate a list and stack credit report typically required by all credit reporting bureaus for credit reports delivered to consumers). However, in other embodiments where a more concise report is desired (e.g, a credit report issued to a loan underwriter), a best representative record is selected from each exclusion partition (see Section II.B.3. infra).

### ILLUSTRATIVE EXAMPLE

For didactic purposes, Table 6 holds the results of applying an exclusion function to the records in each of the equivalence partitions represented in the example of Table 4. supra.

TABLE 6

| | s₁ | s₂ | s₃ | s₄ | s₅ | s₆ | s₇ | s₈ |
|---|---|---|---|---|---|---|---|---|
| s₁ | | 5 | 3 | | | | | |
| s₂ | 5 | | −1 | | | | | |
| s₃ | 3 | −1 | | | | | | |
| s₄ | | | | | 2 | | | |
| s₅ | | | | 2 | | | | |
| s₆ | | | | | | | 4 | 6 |
| s₇ | | | | | | 4 | | 3 |
| s₈ | | | | | | 6 | 3 | |

In the example provided by Table 6, s₂ and s₃ conflict with each other (in one embodiment, this means that the resulting value output by the exclusion function is negative), but are both compatible with s₁. The strength of the compatibilities will determine which record is included with s₁ in the partition. Since ƒₓ(s1,s2)>ƒₓ(s1,s3), s₁ and s₂ will be included in the same partition. Accordingly, the final partitioning after applying one embodiment of the exclusion function is:
Q₁={s1,s2}
Q₂={s3}
Q₃={s4,s5}
Q₄={s6,s7,s8}

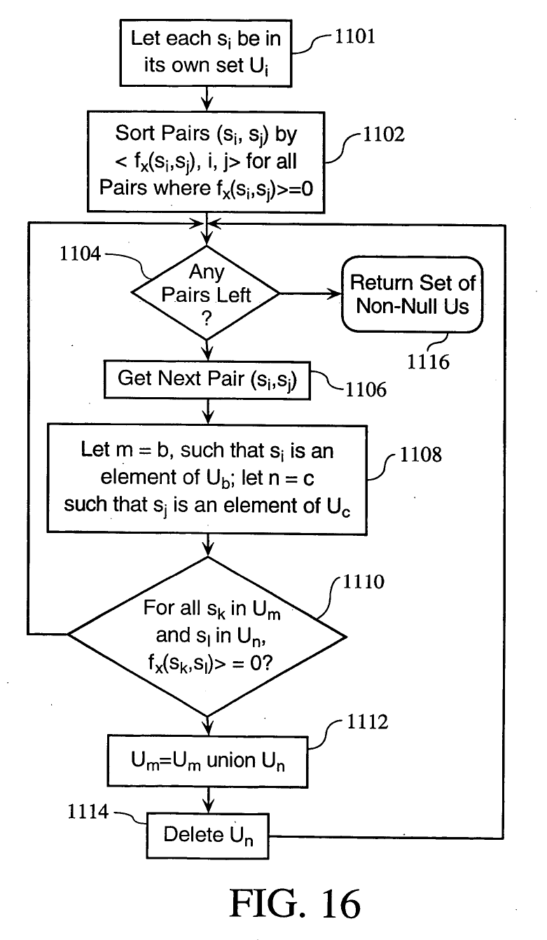

FIG. 16 sets forth a method according to one embodiment for creating exclusion partitions. In one embodiment, partition engine 116 places each record, sᵢ, in its own set, ∪ᵢ (FIG. 16, step 1101). Partition engine 116 then applies an exclusion function to all pairs, (si, sj), in the equivalence partition and sorts all pairs, exhibiting a positive exclusion function value, according to the results of the exclusion function (step 1102). In other words, the pair of records having the highest exclusion function value is placed first, followed by the second highest, and so on. In the example provided by Table 6, supra, the ordering of pairs in the partition including s₁, s₂, and s₃ is s₁-s₂ and s₁-s₃. In one embodiment, the pairs are also sorted by a perturbing value in situations where the exclusion function values between two record pairs are equal. In one embodiment, the sequence indexes, i and j, of the record sets provide the perturbing value. For example, between two record pairs, each having the same exclusion function value, the record pair having the lowest i or j is placed first.

Partition engine 116 fetches the first pair of records, sᵢ and sⱼ, sorted in step 1102 (step 1106) and looks up the indexes (b and c) of the sets ∪_{b} and ∪_{c}, in which sᵢ and sⱼ, respectively are located (step 1108). For the example provided by Table 6, b=1 and c=2 in the first run. Partition engine then determines whether for all records in the set ∪ₘ and all record in the set ∪ₙ, whether ƒₓ(sk, sl)≧0 holds true (step 1110). If so, the record, sⱼ, in ∪ₙ is added to ∪ₘ (step 1112) and ∪ₙ is deleted (step 1114). In the example of Table 6, ∪₁ includes the records s₁ and s₂, while ∪₂ is deleted.

If any pairs remain (step 1104), partition engine 116 fetches the next pair of records (step 1106) [e.g., s₁ and s₃ in the example of Table 6] and looks up the indexes, b and c, of the sets ∪_{b} and ∪_{c} which include sᵢ and sⱼ, respectively. In the example of table 6, b=1(since ∪_{1 contains s}₁) and c=3 (since ∪_{3 contains s}₃). However, s₃ is not added to ∪₁ and ∪₃ is not deleted, since ƒₓ(s2,s₃)=−1. When no pairs remain, partition engine 116 returns the remaining non-null sets (step 1116). In the example of Table 6, the remaining sets are ∪₁ and ∪₃. According to this embodiment, these remaining sets define the exclusion partitions Q_{1 and Q}₂, supra.

Similar to equivalence partitioning, the actual exclusion functions, in one embodiment, vary across credit report data categories. The following provide illustrative examples of exclusion functions for the tradeline and public record categories:

a. Tradeline Exclusion Function

As one will recognize from the function outlined below, in one embodiment, the exclusion function provides an indication of the degree of compatibility between two records, wherein a negative value indicates that two records are incompatible. In one form, “source” means the particular credit file from which the particular record originated. In one embodiment, the exclusion function deems two records originating from the same credit file as two separate items and, therefore, places them in two separate partitions.

Float f_{X}(a,b)
{

score = MinLCSRatio(a.accountNumber, b.accountNumber)
If (a.source == b.source)

Return −1

If (a.balance = b.balance)

Score = score + 3

If (a.highCredit = b.highCredit)

Score = score + 3

If (a.creditType == b.creditType)

Score = score + 3

Return score

}

b. Public Record Exclusion Function

As with the Tradeline Exclusion function, in one embodiment, the Public Record exclusion function deems two records originating from the same credit file as two separate items and, therefore, places them in two separate partitions.

Float f_{X}(a,b)
{

If (a.source == b.source)

Return −1

Else

Return 1

}

3. Merging of Data

As discussed above, items or records across at least two credit reports are partitioned, in one embodiment, in a pair-by-pair evaluation of equivalence. After a data set has been partitioned (either by equivalence functions or by equivalence and exclusion functions), merge engine 120, in embodiments where a concise report is desired, operates to merge the data in each partition. In one embodiment, merge engine 120 employs functions that facilitate the selection of the best representative item or record in each partition and uses such item or record in the merged credit report displayed to the user. In another embodiment, merge engine 120 operates on the data in each partition to select data within each item or record to gather the most informative and accurate data.

a. Best Representative Record

In one embodiment, the best representative record is determined by applying a function, ƒ_{B}(si,sj), that returns a value indicating which of two records is preferred. A true value, in one embodiment, indicates that the first record (sᵢ) is preferred over the second. Therefore, the set containing the best representative record from each partition is defined by

$$B = {{⋃}^{M}}_{m = 1} \{ {s}_{j} \vert {s}_{j} ∈ {P}_{m} ⋀ {∀}_{sk ∈ {P}_{m} , k \neq j} {f}_{B} ( {s}_{j} , {s}_{k} ) \} .$$

In one embodiment, the best representative function operates on equivalence partitions. In another embodiment, the best representative function operates on exclusion partitions.

For didactic purposes, Tables 7, 8, and 9 provide the relative rankings between records (s₁-s₈ of Table 5) according to one embodiment of the best representative function. These tables indicate that s₂, s₄, and s₈ are the best representative records within their respective partitions.

TABLE 7, 8 & 9

| | s₁ | s₂ | s₃ | | s₄ | s₅ | | s₆ | s₇ | s₈ |
|---|---|---|---|---|---|---|---|---|---|---|
| s₁ | | T | | s₄ | | T | s₆ | | T | |
| s₂ | T | | T | s₅ | | | s₇ | | | |
| s₃ | | | | | | | s₈ | T | T | |

### 1) Best Representative Supporting Functions

In one embodiment, the functions to select the best representative item, like equivalence functions, include supporting functions. In one embodiment, for example, merge engine 120 using the WorstMOP function (15) scans items or records in the tradeline category to extract information relating to delinquent payments corresponding to particular loans. In one embodiment, unlike the supporting functions like CompDate and CompAcct, the function WorstMOP operates within each record or item representing a particular loan/mortgage/account to extract the latest payment and does not compare latest payments between two records or items. As discussed below, this comparison occurs during determination of the best representative record.

$$WorstMOP ( late 30 , late 60 , late 90 ) = \{ \begin{matrix}4 , if late90 > 0 \\ 3 , if late90 = 0 and late60 > 0 \\ 2 , if late90 + late60 = 0 and late30 > 0 \\ 0 , if late90 + late60 + late30 = 0\end{matrix} \qquad ( 15 )$$

Embodiments of the present invention further include the Worst24MOP function that returns the highest WorstMOP value within the last 24 months of the user's credit history.

2) Best Representative Functions

As discussed above, merge engine 120 selects the best representative record in a partition for inclusion in the merged credit report. In one embodiment, the functions used to select the best representative record within a partition vary depending on the credit report category. The following functions provided an illustrative example:

### a) Tradeline Best Representative Function

Bool f_{B}(a,b)
{
If (a.DateReported <> b.DateReported)

Return (a.DateReported > b.DateReported)

If (a.WorstMOP <> b.WorstMOP)

Return (a.WorstMOP > b.WorstMOP)

If (a.HighestBalance <> b.HighestBalance)

Return (a. HighestBalance > b. HighestBalance)

Return (Length(a.CreditorName) >= Length(b.CreditorName))
}

### b) Public Records Best Representative Function

Bool f_{B}(a,b)
{

if (a.ClosingDate <> b.ClosingDate)

return (a.ClosingDate > b.ClosingDate);

return (a.Amount > b.Amount);

}

c) Inquiries Best Representative Function

Bool f_{B}(a,b)
{

return (Length(a.SubscriberName) >= Length(b.SubscriberName))

}

C. Credit Monitoring

Credit report site 30, in one embodiment, offers users the ability to monitor credit history on a periodic basis. In one embodiment, credit report site 30 allows a user to purchase, in advance, 12 monthly credit reports. The credit reports are generated automatically by monitoring engine 112 once each month. In one embodiment, each generated report is then compared to the previous month's report and the user is notified of any additions, deletions, or changes to credit information. In one embodiment, the user has the option of receiving a change notification via email or postal mail. In one embodiment, users are provided the option to specify the parameters or criterion triggering a notification of a change in credit.

1. Registration for Credit Monitoring

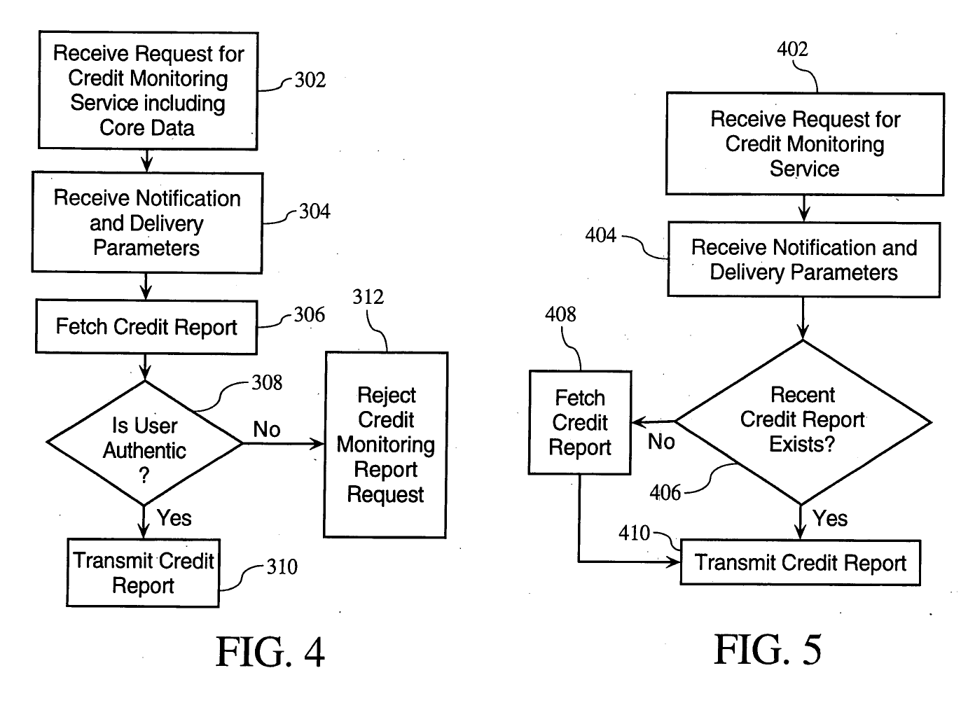

FIG. 4 illustrates a method allowing registration of first-time users for credit monitoring services according to one embodiment of the present invention. As FIG. 4 shows, credit report site 30 receives a request for credit monitoring services (FIG. 4, step 302). In one embodiment, credit report site 30 prompts the user for and receives core data, as described above, sufficient to fetch a credit report from credit reporting bureau 50. In addition, the user specifies and credit report site 30 receives notification parameters relating to the types or categories of credit report changes about which the user wishes to receive notification (step 304). Credit report change categories or notification parameters can relate to changes in any data field in the credit reports. In one embodiment, such notification parameters include, but are not limited to, 1) new tradelines, 2) new delinquencies, 3) new public records, 4) new inquiries, 5) changes in personal information, and 6) changes in credit limits. In addition, credit report site 30 also provides users certain notification delivery options. In one embodiment, such options comprise e-mail notification and regular postal mail notification. In one embodiment, the notification parameters and delivery options specified by the user are stored in user account database 110 in a corresponding user account. In one embodiment, notification parameters include the frequency at which the user wishes credit reports to be retrieved and notified of changes. In the embodiment of FIG. 4, credit report site 30 fetches a credit report using the core data provided by the user (step 306) and authenticates the user (step 308). In one embodiment, validation module 104 authenticates the user by validating the core data and confirmation data provided by the user according to the methods described above (see FIG. 3). If the user is properly authenticated, credit report site 30 transmits the credit report (step 310). Otherwise, the credit report monitoring request is rejected (step 312).

FIG. 5 illustrates a method allowing registration of existing users for credit monitoring services. Similar to above, credit report site 30 receives a request for credit monitoring services from an existing user (FIG. 5, step 402). Credit report site 30 also receives notification parameters and delivery parameters from the user (step 404). In one embodiment, monitoring module 112 stores the notification and delivery parameters specified by the user in user account database 110. Monitoring module 112 then accesses credit report database 108 to determine whether a sufficiently recent credit report exists (step 406). If a sufficiently recent credit report exists, monitoring module 112 transmits the credit report to the user (step 410). Otherwise, credit report site 30 fetches a new credit report from credit reporting bureau 50 (step 410).

In one embodiment, the notification parameters include parameters that control the timing and frequency at which credit reports are fetched. In one embodiment, credit report site 30 by default fetches a credit report for a particular user on a monthly basis from the day he or she first registered for credit monitoring services. In one form, this registration date is stored in user account database 110 in a record embodying the user's account and, as discussed below, determines in part the timing at which credit reports for that user are fetched. In another embodiment, credit report site 30 allows the user to specify the day of the month or frequency at which a credit report is fetched.

2. Monitoring Changes in Credit Information and Notification of Users

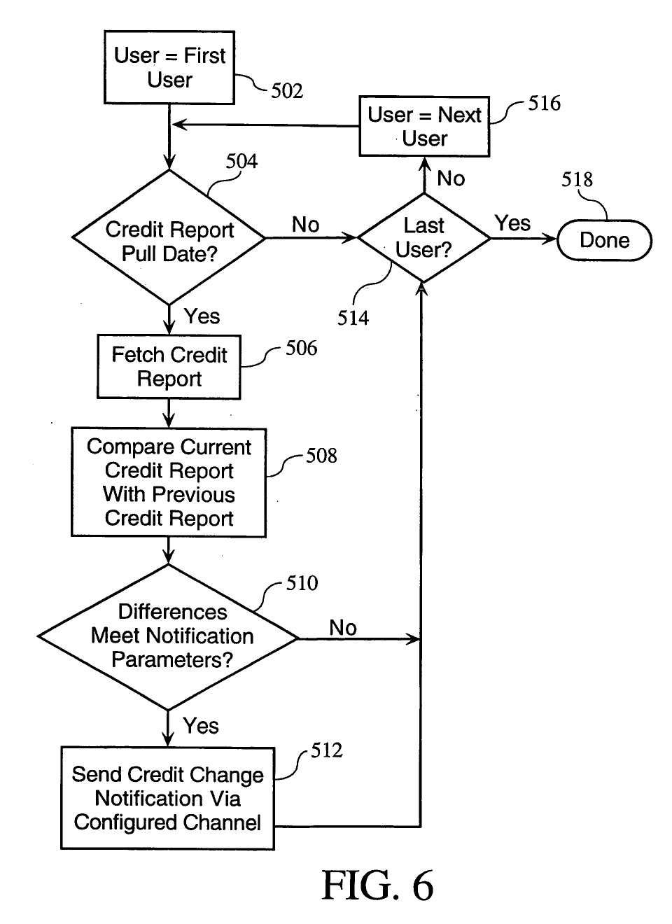

FIG. 6 illustrates a method allowing for monitoring of credit information among a plurality of users of credit report site 30. In one embodiment, starting with the first user identified in user account database 110 (FIG. 6, step 502), monitoring module 112 accesses the notification parameters associated with the user to determine whether a credit report should be fetched (step 504). In one embodiment, if the credit report pull date matches the current date, credit report site 30 fetches a new credit report (step 506) and stores it in credit report database 108 in association with the user's account identification. In one embodiment, monitoring module 112 compares the current credit report with the previous credit report stored in credit report database 108 (step 508) to determine the differences or changes between them. Monitoring module 112 then determines whether any of the differences meet the notification parameters specified by the user (step 510). If the differences fall within the notification parameters specified by the user, monitoring module transmits a credit change notification according to the delivery parameters specified by the user (step 512). As FIG. 6 shows, this process is repeated for a plurality of users (see FIG. 6, steps 514, 516 and 518).

In one embodiment, credit report site 30 provides users with a variety of credit monitoring options. In one embodiment, users log in and authenticate themselves by providing a password. Users may then view the most recent credit report pulled by monitoring module 112. Credit report site 30 also allows users to view past credit reports. In one embodiment, credit report site also allows users to choose two credit reports and generate the differences between them. In addition, users may also change the notification and delivery parameters associated with the account.

3. Credit Difference Engine

Embodiments of the present invention employ a credit difference engine 114 to detect changes or differences between two credit reports. In one embodiment, the credit difference engine performs a pair-wise comparison between the contents of two credit reports for the purpose of supporting services that require credit profile change information, including the display of credit profile changes to end users. In one form, a user logs into existing account with at least two previous credit reports available in credit report database 108 and selects the credit difference services from a menu screen. In one embodiment, a list of available credit reports is displayed to the consumer, from which the user selects two credit reports. The difference engine compares the content of the two credit reports and generates a new ‘Difference’ credit report which indicates the changes to the user's credit state.

In one embodiment, the ‘Difference’ credit report is formatted according one or more of the following rules: 1) If an item is unchanged between the two reports, then it is rendered the same as it would in a single credit report; 2) If an item is changed between two reports, then the item is displayed twice: once in its original state, and once in its new state (In one form, the details that have changed are highlighted within their formatting); 3) If an item in the old report does not have a match in the newer report, then the entire item is highlighted to reflect that the item has been removed; and 4) If an item in the newer report does not have a match in the older report, then the entire item is highlighted to reflect that the item has been recently inserted into the credit profile. In one embodiment, credit report site 30 allows the user to select alternative display formats for the Difference Report. For example, the user can choose to view a report that only displays items that have changed between the two reports, or the consumer can choose to filter the report for specific types of changes.

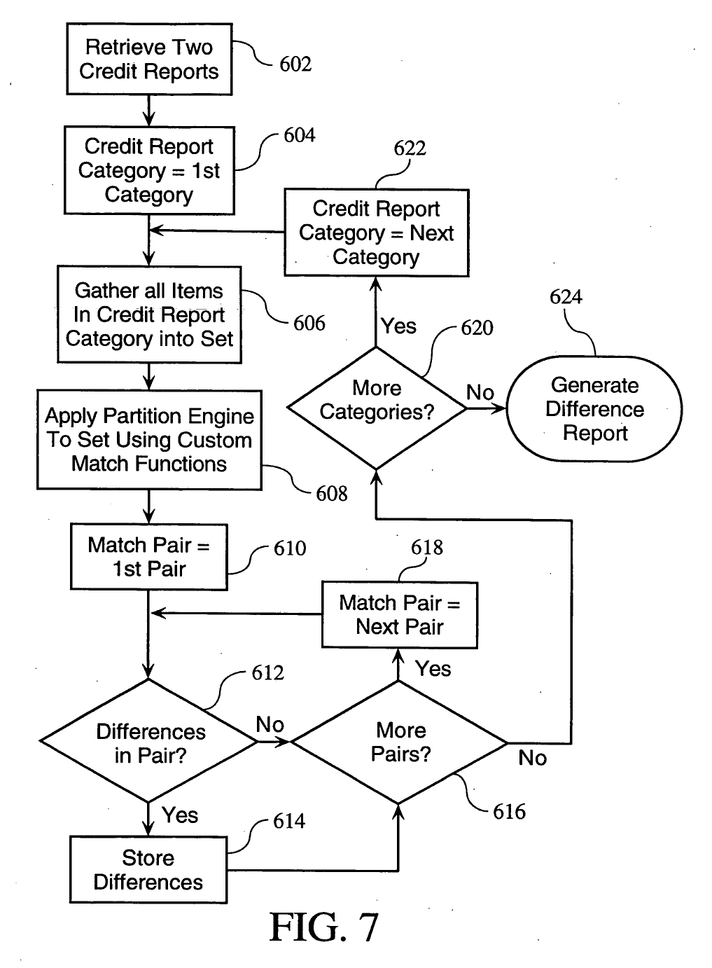

FIG. 7 illustrates the operation of one embodiment of the credit difference engine according to the present invention. In one embodiment, credit difference engine retrieves two credit reports specified by the user (FIG. 7, step 602). In one embodiment, credit difference engine 114 retrieves the two latest credit reports corresponding to the user by default if the user does not specify any credit reports or if the user selects a “Quick Compare” option. Credit difference engine 114. starting with the first credit report category (step 604), assembles all items in the corresponding credit reports for the current credit report category into a data set (step 606). Partition engine 116 then matches corresponding elements in the current data set into match pairs (step 608) based upon custom matching functions, which, in one embodiment, are specific to the current credit report category. In one embodiment, operation of partition engine 116 is based on equivalence and, optionally, exclusion, as discussed above. The differences, if any, between each element of the match pairs are determined and stored (see FIG. 7, steps 610, 612, 614, 616 and 618). This process is repeated for each credit report category (see FIG. 7, steps 620 and 622). The resulting stored data is then used to generate a ‘difference’ report, which in one form is formatted according to the rules described above (step 624).

In one embodiment, the same base partition engine used in merging reports (see Section II.B., supra) is used in connection with difference engine 114. However, the difference engine uses its own custom scoring functions for driving the match process to compensate for the requirements involved in comparing two chronologically spaced credit reports. In addition to matching up items between the two reports, certain chronological details need to be properly aligned before rendering the difference between two reports. For example, each tradeline, in one embodiment, contains a Manner of Payment History that is an array of account payment statuses where adjacent statuses represent a one month time period. The contents of this array will shift over time as the account's subscriber reports new information.

In one embodiment, credit difference engine 114 operates alone or in combination with credit monitoring engine 112 or other services offered by credit report site 30. Although the display of credit profile changes is useful in itself, this functionality becomes even more valuable when incorporated within the Credit Monitoring and Credit Cleanser services. As discussed above, Credit Monitoring services, according to one embodiment, allow consumers to be automatically notified on a periodic basis when certain events occur with their credit profile. Use of the credit difference engine, in some embodiments, increases the sophistication of the notification options. Specifically, rather than notifying a user based upon a single snapshot of data, Credit Monitoring services can notify users when any of a wide variety of changes occur to their credit profile. For example, if an item has been removed from a credit profile, then a snapshot will fail to reflect this information, since a previous credit report is necessary to provide the comparison. In addition, Credit Cleanser services, as discussed more fully below, allow users to request and track corrections to their credit profile. In conjunction with credit difference engine, Credit Cleanser services can automatically update the status of correction requests when changes appear in newly pulled credit reports.

D. Credit Cleanser

In one embodiment, credit report site 30 facilitates the updating and/or correction of credit report data. In one embodiment, credit report site 30 facilitates correction of inaccurate data on a user's credit report. In one embodiment, credit report site 30 provides standard dispute letters to users. Each dispute letter is customized for each type of dispute for each type of credit report item. In one embodiment, the user is given an opportunity to modify the contents of the letter. In one embodiment, credit report site 30 provides forms and utilities to assist the user in further customizing the dispute letter. In one embodiment, credit report site 30, using data submitted by the user as well as data in the user account database 110 auto-populates the dispute letter form.

For each type of credit report item, different corrective action and, hence, a different dispute letter are required. For example, if a user's current address is incorrect, an appropriate dispute letter would ask a credit reporting bureau to correct the user's address. However, if a tradeline item is reported as open even though it was closed years ago, the user will need to write a letter to the creditor asking them to report the closure to the proper credit reporting bureau.

In one embodiment, the interface provided to the user includes the user's most current credit report and interface controls that allow the user to launch the credit cleansing services offered by credit report site 30. In one embodiment, the interface includes a “Credit Cleanser” button next to each piece of credit report data that can be disputed. When the “Credit Cleanser” button is clicked, the user is taken to a menu of options for that credit report data type. Several ways of implementing the above-described interface are known in the art, including, but not limited to page-based interfaces, such as HTML pages, or Java applets embedded in such pages, both of which are transmitted to browser 62 on client computer 60.

In one embodiment, clicking on the “Credit Cleanser” button that appears on the screen next to a piece of credit report data (see below) brings up a wizard allowing the user to customize a letter for the particular dispute. In one embodiment, for every type of credit data, the user is given the option to create a letter from scratch. In one embodiment, the user has several dispute options for a particular type of credit report data. In one form, the interface provided to the user includes an “options” menu that allows the user to identify the problem associated with the particular item of credit report data. In one embodiment, a dispute “wizard” optimized to the particular problem identified by the user is invoked. In one embodiment, if there is no particular dispute wizard associated with the problem identified by the user, the user is provided the option to create his or her own letter using a “generic” letter option.

As discussed above, each type of dispute, in one embodiment, has a particular wizard associated with it. A wizard exists to help the user gather the correct information to send in the dispute letter for the particular dispute. After the user has gone through the wizard, a letter is generated for them. The letter is then shown to the user, who can edit any aspect of that letter. This includes the body of the text, the address the letter is sent to, the person the letter is sent to, who the letter is from, the return address, and all of the other standard elements of a letter. An example of this is the personal information wizard. If there is incorrect information in the personal information section of the credit report, a user invokes this wizard to generate a letter containing the old information, the new information, and a reason why it has changed (or is incorrect).

In one embodiment, the wizard auto-populates information in the letter with information previously collected from the user and information from the credit report. For example, the return address for the letter is pre-populated with the mailing address that the user entered when he ordered the credit report. When the user has made his modifications to the letter, he is given the option of how to view the letter (so he can print it on his client machine). In one embodiment, the file format options available are HTML, PDF, RTF and TXT. When the user chooses the view option, he is taken to a page that displays the letter in the format chosen.

In one embodiment, when a user generates a letter using Credit Cleanser services, he or she is given the option to save the letter in a user account for future use. He can choose to resend his letter, which records the second send in the user account database. On his third send, the body of the letter, in one embodiment, is changed slightly to inform the receiver of the letter that this is the third time. Of course, the user can override the body and change the wording.

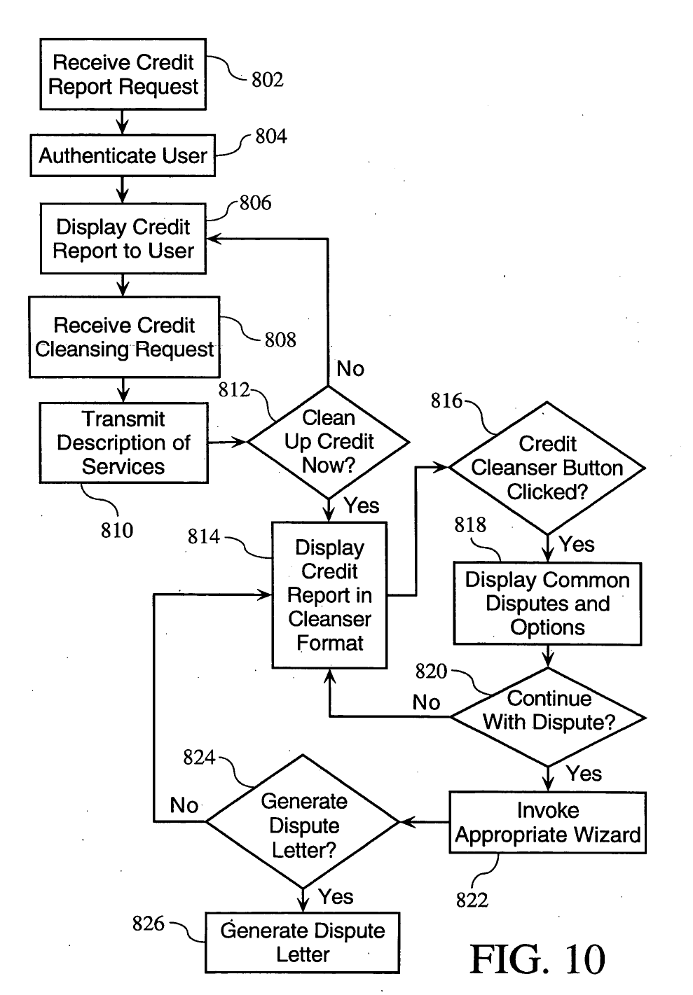

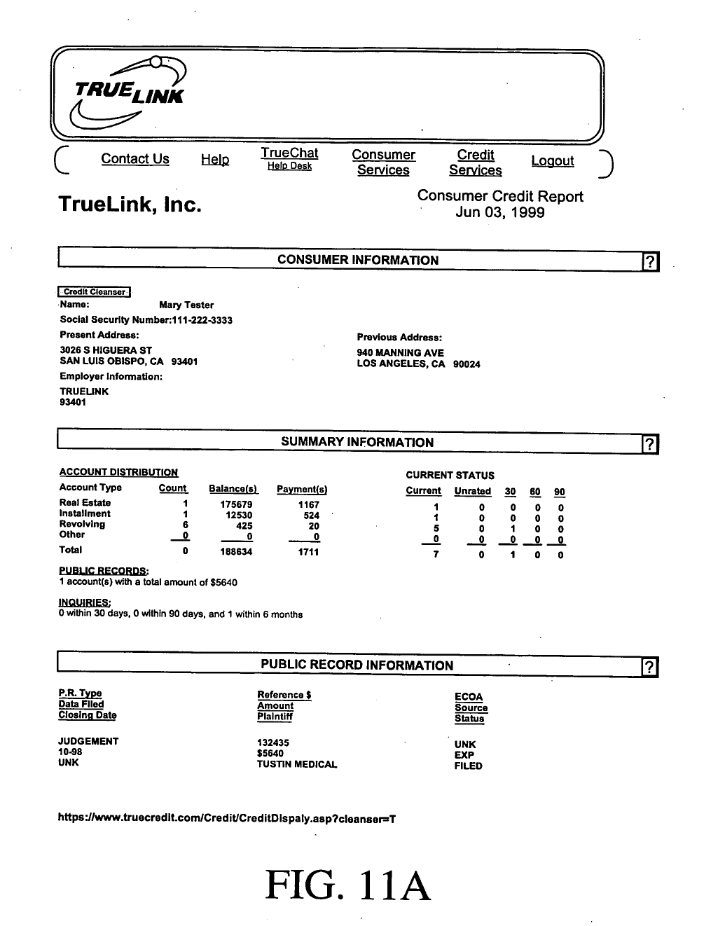

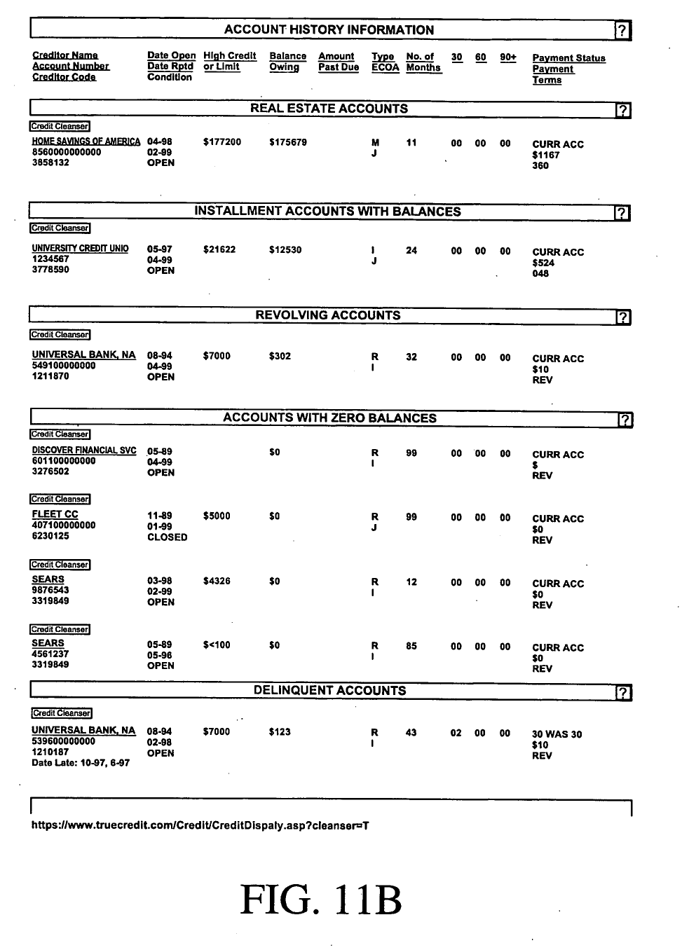

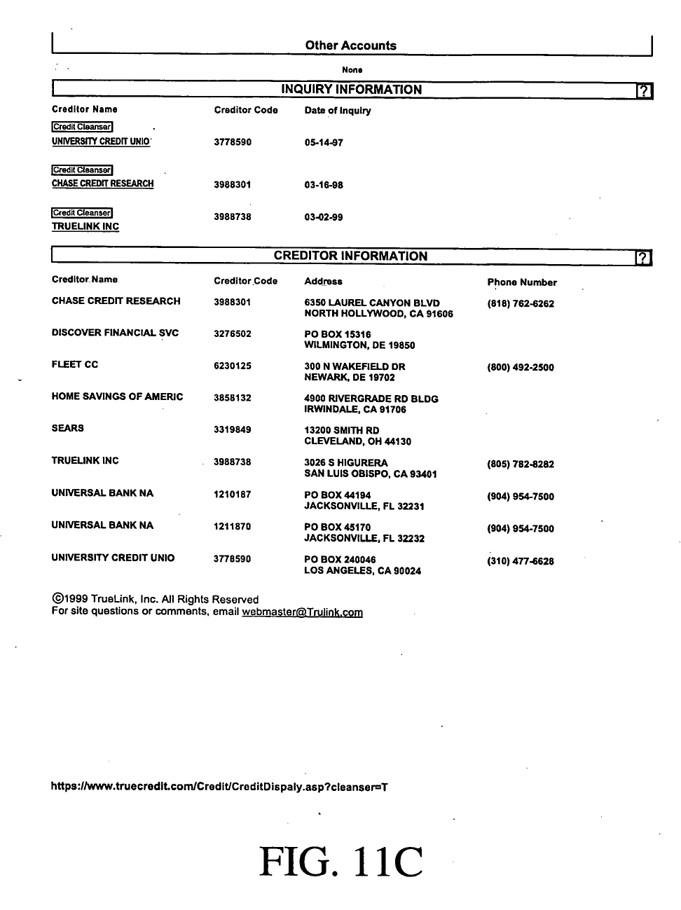

For didactic purposes, FIG. 10 illustrates an example of the operation and functionality of one embodiment of the credit cleansing services of the present invention. A user transmits and credit report site 30 receives a credit report request (FIG. 10, step 802). Credit report site 30 authenticates the user as discussed above (step 804). If the user is properly authenticated, credit report site 30 electronically delivers the credit report to the user (step 806). In one embodiment, the page including the user's credit report request includes a link entitled “See Something Wrong?”. Assume that the user notices that his Chase credit card is listed as open and he knows that he closed it 3 years ago. The user clicks on the “See something wrong?” link at the top of the page (step 808) and is taken to a description of Credit Cleanser (step 810). The page including the description includes a “Cleanse my Credit Now” link. When the user clicks on the “Cleanse my Credit Now” link (step 812), credit report site 30 transmits the user's credit report in a different format, namely, the Credit Cleanser Credit Report View, which has “Credit Cleanser” buttons next to each item on the report, including the user's Chase credit card. (See FIGS. 11A-C). In the example, the user on the “Credit Cleanser” button that appears next to his Chase account (step 816). This opens up a page that contains a list of “Common Disputes with Credit Card accounts” (step 818). The user reads through the common disputes, and notices one labeled, “This account is marked as Open, even though I closed it”. The user clicks on the label and is taken to a page that explains to him that it can sometimes take several months for a closed account to appear as such on the credit report. In this example, the user decides that it has been plenty of time and chooses the “Continue with Dispute” option over the “Ill come back later” option (step 820). The user is then taken to the “Account Closed Wizard” (step 822), which asks him for the approx. date on which the account was closed and the reason for the account closure. After the user completes the requested information, the clicks on the “Generate Dispute Letter” button (step 824). In one embodiment, the user is presented with an editable version of the dispute letter, pre-populated with appropriate information from the user's account and credit report (step 826). The user may add a special note to the body of the letter. In one embodiment, the user is offered various printing and/or display formats for the dispute letter. In the example, the user chooses the HTML format, causing a new browser window to appear containing only the dispute letter in text format. The user may then print the letter using the print function of the browser. The user may then close the window and return to the credit report to search out more inaccurate information.

In one embodiment, credit report site 30 allows users to register disputes relating to inaccuracies in their reported credit history. In order to register a dispute, a user must first have a viewable credit report. If not, then the user will be required to order a credit report In one embodiment, the user can dispute items in his credit report by using the Credit Cleanser service (either directly from a displayed credit report with Credit Cleanser links, or from the Credit Analyst service). When a dispute letter is generated, it may be delivered electronically or by certified mail to the appropriate parties (e.g. the credit repository and/or the credit grantor). In one form, when this occurs, the dispute information is stored with the user's account.

In one form, credit report site 30 allows the user to track the progress of disputes and to maintain and manage a history of dispute resolutions. One embodiment includes the auto-population of dispute letters, (optional) automatic delivery of disputes to the relevant parties, recommendations and generation of follow-up letters, storage of the dispute content for later review, and automatic detection and notification of dispute resolution. In one embodiment, when a user sends a dispute letter, the information about that dispute is saved in association with the user's account. In one embodiment, if the user logs in to credit report site 30 and requests a credit report, credit report site 30 displays the credit report data with flags indicating any items on the credit report involving a currently open dispute.

Once the user has created and sent the letter, Credit Cleanser can track the user's letters and monitor what effect they have. By tying into other services offered by credit report site 30. the user can be automatically notified of the effect of their disputes. In one embodiment, when the user returns and requests another credit report, his credit history disputes are checked against his new credit report. The user can check to see if his changes have taken effect. The user may choose to be automatically notified of a positive dispute effect when he logs in. If a user chooses to participate in Credit Monitoring, Credit Cleanser, in one embodiment, will automatically check for positive dispute effects in the new credit report and will notify the user in the manner specified in Credit Monitoring of the positive results.

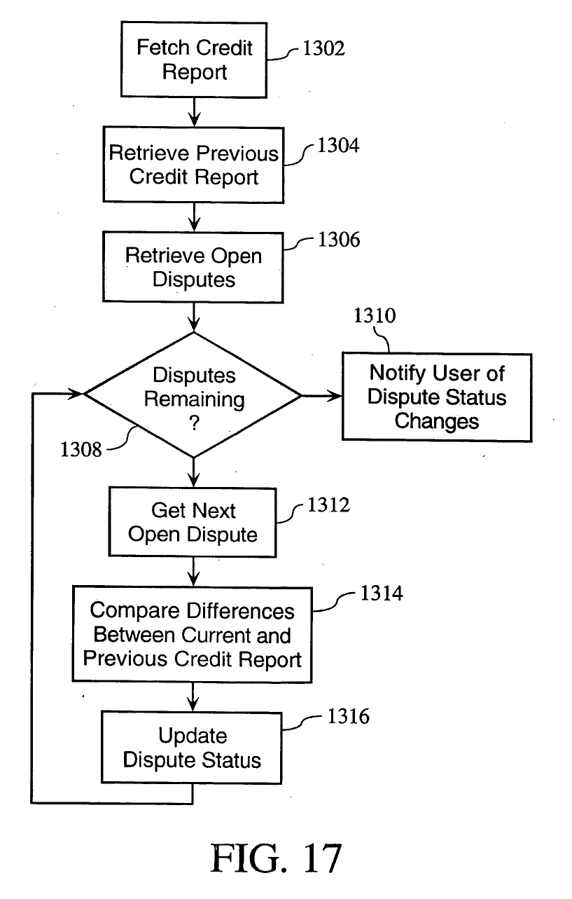

FIG. 17 provides a method for tracking changes resulting from dispute letters. In one form, credit report site 30 fetches a credit report from a credit reporting bureau 50 (FIG. 17, step 1302). The credit report can be fetched on a periodic basis as described in steps 502, 504, 506, 514 and 516 of FIG. 6. In another embodiment, a credit report is fetched automatically when the user logs into credit report site 30. In yet another embodiment, a credit report is fetched when the user invokes the credit tracking services of credit report site 30. According to one embodiment, credit report site 30 also retrieves the last previous credit report and open disputes associated with the user's account (steps 1304 and 1306). In one embodiment, for all open disputes (see steps 1308 and 1312), credit report site 30 compares the differences relevant to each dispute between the current credit report and the previous credit report (step 1314) and updates the status of the particular dispute (step 1316). In one embodiment, the partitioning and differencing methods discussed above are used to match corresponding items in each credit report and compare the differences. Credit report site 30 then notifies the user of any changes in the status of the disputes associated with the account (step 1310).

In one form, credit report site 30 automatically (or optionally with direct user request) pulls a credit report for a user similar to the protocols and methods described in the Credit Monitoring services of one embodiment of the present invention. In one embodiment, if that user has unresolved disputes, then the new credit report will be differenced with the previous credit report (see Credit Differencer). The unresolved disputes are matched up with their corresponding items within the credit difference report. If an item difference indicates that the disputed item has been corrected, then the status of the dispute are updated and the user is automatically notified of the correction. In one embodiment, credit report site 30 notifies the user via e-mail.

As part of the dispute tracking system of one embodiment, the user may logon and review the history and state of their submitted disputes. When the user first enters the dispute tracking service, a summary of existing disputes are displayed with an indication of the dispute status (e.g., still unresolved, corrected, conceded by consumer). The user may select a particular dispute and display the event history for that dispute. This shows a chronology of actions that occurred for the dispute, including but not limited to submitted dispute letters, changes to the content of disputed items, and changes to the status of the dispute. With any unresolved dispute, the user may, in one embodiment, manually choose to flag the dispute as ‘conceded’ or may choose to send a follow-up letter or to perform some other action.

E. Credit Analyst

Credit report site 30, in one form, includes services relating to the analysis of a user's credit history and the provision of recommendations for establishing better credit. In one embodiment, credit report site 30 offers a web-based application that analyzes a consumer credit report and provides advice to the user on how to improve his or her credit standing. In one embodiment, this application 1) identifies potential problems and inaccuracies on a credit report; 2) prioritizes problems in a plan of action; 3) provides instructions to the consumer on steps needed to complete each action item; and 4) provides links to credit cleansing tools used to generate auto-populated letters (see Section II. D, supra). In one embodiment, the credit analyst application works in conjunction with the credit report retrieval and delivery service which retrieves credit data from the credit reporting bureaus, and the credit cleansing services, discussed above, which assist the user in correcting inaccuracies and closing unused accounts.

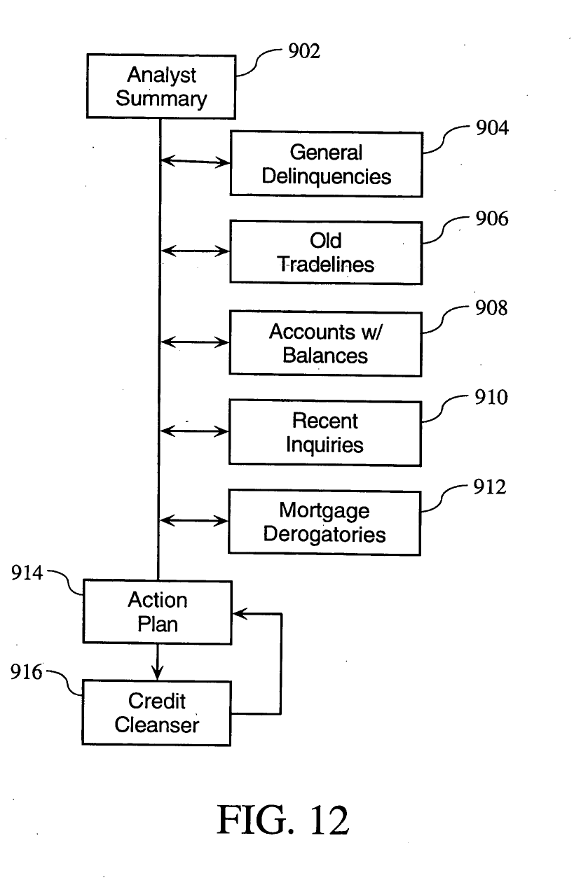

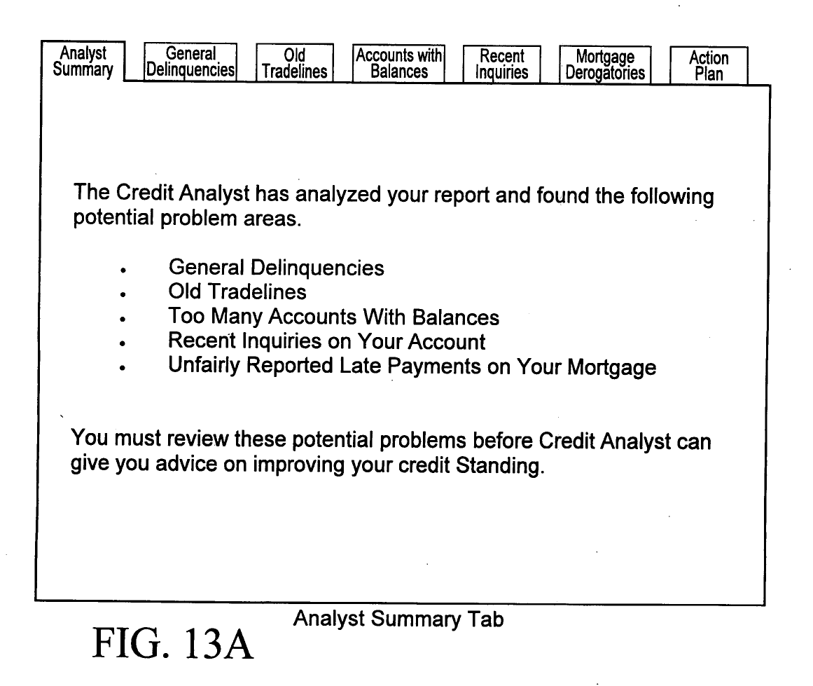

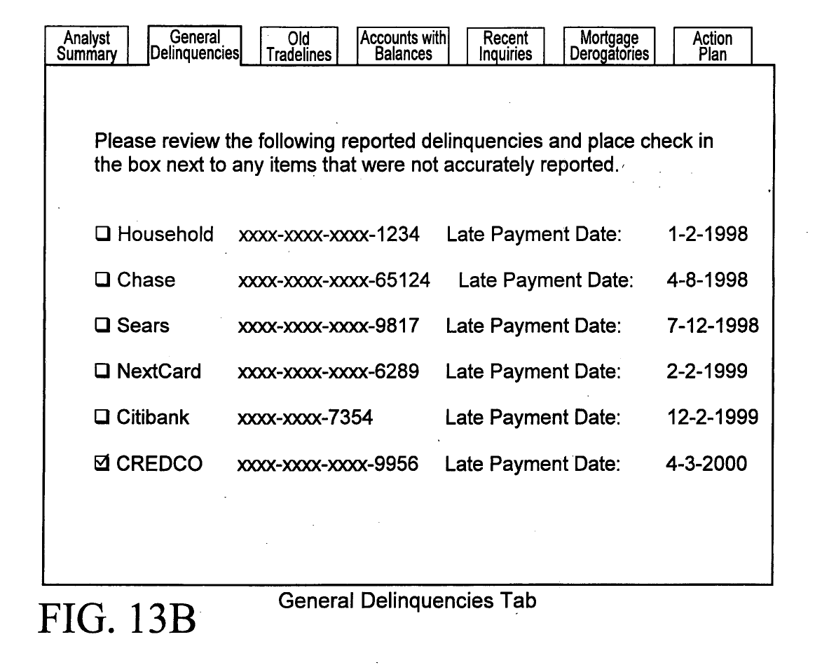

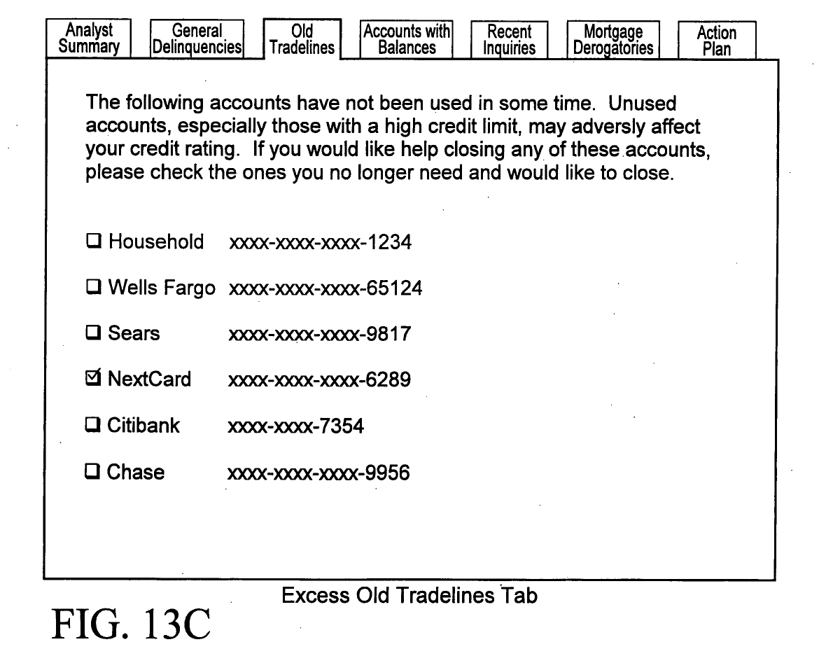

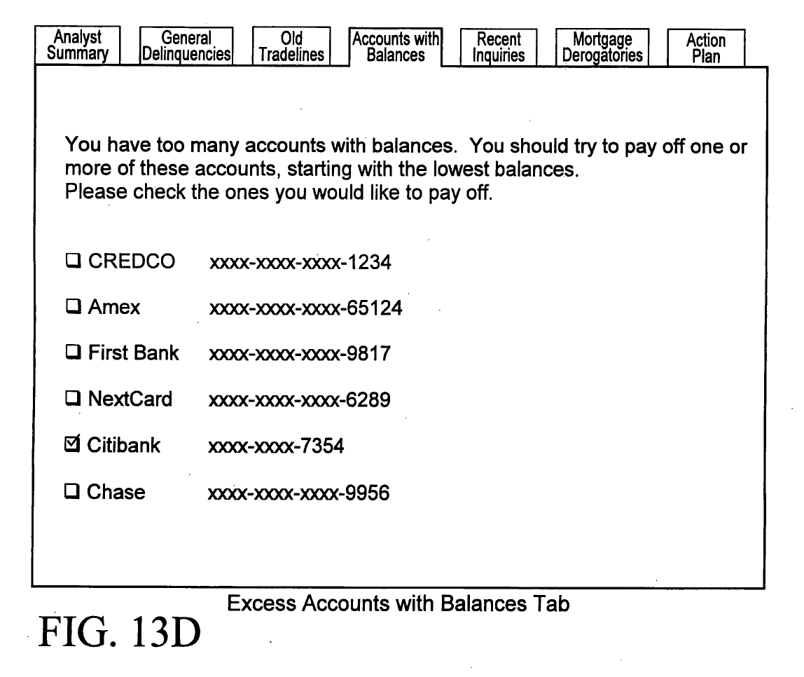

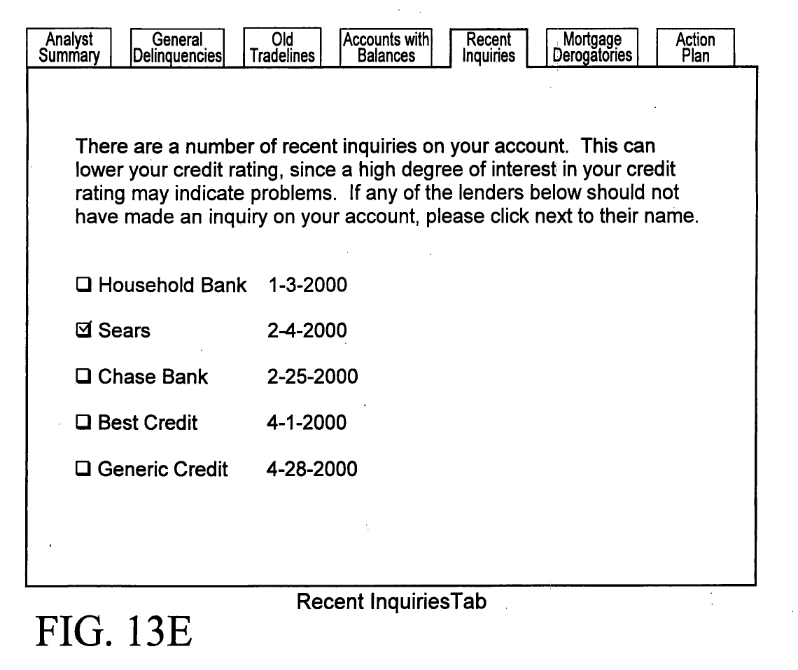

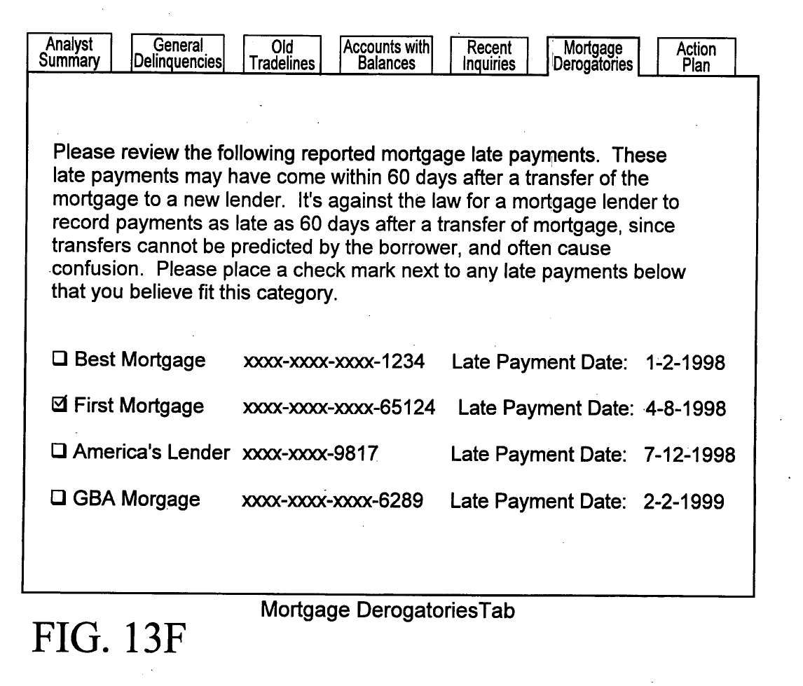

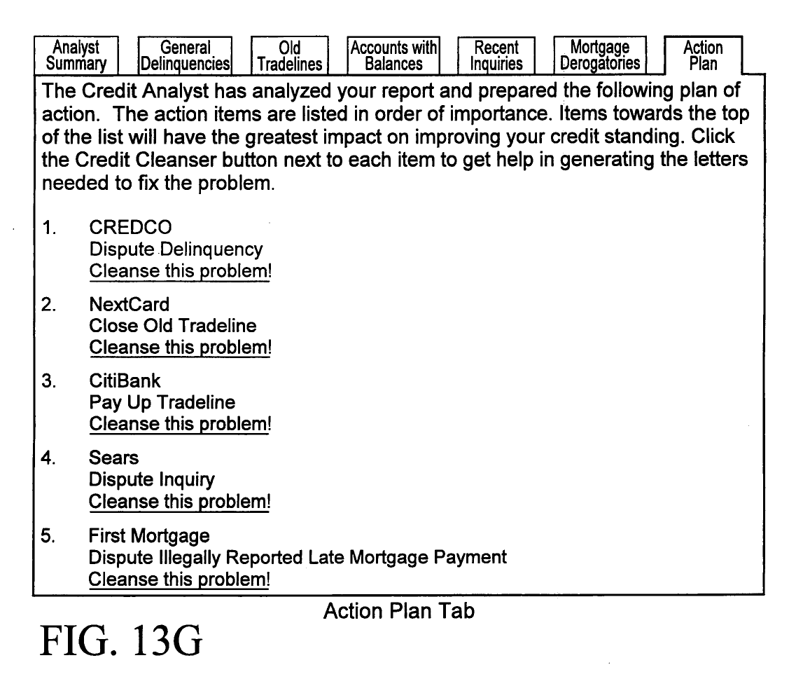

Application flow according to one embodiment is shown in FIG. 12. In one embodiment, a user enters the Credit Analyst application from a link in credit report site's credit report services. Assuming that credit data has already been retrieved and is available in the database, credit report site 30 scans the data in the credit report and constructs an application interface including credit report data associated with the user. In one embodiment, the application interface is a page-based interface comprising a set of tabbed pages with the following labels: Analyst Summary, General Delinquencies, Old Tradelines, Accounts with Balances, Recent Inquiries, Mortgage Derogatories, Action Plan. See FIGS. 13A-G. Using the tabs, the user navigates through pages dedicated to the various types of problems identified in the credit report. In one embodiment, problem categories include general delinquencies, old tradelines, excessive accounts with balances, excessive recent inquiries, and illegal mortgage derogatories. In one embodiment, the application interface forces the user to visit all available tabs before moving to the Action Plan. Each tab presents the details of the potential problems that were identified, and allows the user to determine which items are actually problems. In one embodiment, the Action Plan lists all problems identified by the user in order of severity, and provides a link into the credit cleansing services of credit report site 30 such that the user may take action to remedy the problems.

The following details the functionality of each of the tabbed pages in the application interface according to one embodiment of the present invention.

Analyst Summary: If no potential problems were identified on the credit report, this is stated here. Otherwise, the summary contains a list of the types of problems identified in the report. For each category that is listed here, a tab appears in the interface. Each of these tabs, in one embodiment, must be visited before the user is allowed to continue to the action plan.

General Delinquencies: Delinquencies, in one embodiment, are listed here by creditor name, account number, and reported late payment date. For each tradeline, a check box is provided such that the user may mark delinquencies which were not accurately reported.

Old Tradelines: Accounts that have zero balances, significant (e.g., >$100) limits, or have been out of use for at least two years are listed here. Use, in one embodiment, is based on the last reported date listed for the tradeline.

Excess Accounts with Balances: If the number of accounts with balances over $100 exceeds a count threshold of 3, all accounts with balances are listed here by creditor name and account number. Check boxes are provided for each tradeline such that the user may select which accounts they would like to pay off and close out. In one embodiment, credit report site 30 recommends to the user that he/she select one or more accounts to pay off, beginning with those with the lowest balances.

Excess Recent Inquiries: If the number of inquiries that have occurred in the last year exceeds 2, all inquiries are listed here by subscriber name and inquiry date. A check box is provided for each inquiry such that the user may identify any that were not authorized.

Mortgage Derogatories: Any mortgage tradelines with derogatories are listed here by creditor name and reported late payment date. The user is informed that late payments may have come within 60 days after a transfer of the mortgage to a new lender and that it is against the law for a mortgage lender to record payments as late for 60 days after a transfer of mortgage, since transfers cannot be predicted by the borrower, and often cause confusion. Check marks are provided such that the user may identify any that qualify as illegally reported mortgage derogatories.

Action Plan: The action plan consists of a list of the problems that have been identified by the user in order of importance. Items towards the top of the list will have the greatest impact on improving the credit standing of the user. In one embodiment, the relative importance of the problems is determined by severity ratings that are calculated according to the rules described below. In one embodiment, a button is provided next to each item which launches the credit cleansing application which assists in generating the letters needed to fix the problem.

1. Problem Severity Determination Rules

Below is an example of rules for determining the severity of commonly encountered credit problems. As one skilled in the art will recognize, the specific numeric values and thresholds used are not critical to the invention and may vary substantially without departing from the scope of the invention.

General Delinquencies:

A tradeline can have multiple general delinquencies reported by the Credit Analyst, since many credit reporting bureaus maintain a delinquency history of up to 36 months. In one embodiment, the severity rating decreases as the number of days a payment is/was late decreases and/or the-time of default becomes more remote. In one embodiment, if an account was delinquent, Credit Analyst rates the severity of the delinquency according to the following:
Severity=(daysLate/3−monthsAgo*50/36),
where daysLate in {30, 60, 90, 120, 150 } and 1<=monthsAgo<=36. If account was defaulted (e.g. Foreclosure, Repossession, Collections),
Severity=(100−monthsAgo*100 /36),
where 1<=monthsAgo<=36.
Old Tradelines:

If an account (not closed) has not been reported or used in the last 6 months then:
Severity=(creditLimit/200+monthsUnused*5/12).
Excess Accounts with Balances:

If there are more than 3 accounts with positive balances:
Severity=50*(positiveAccounts−3),
where positiveAccounts is the number of accounts with positive balances.
Excess Recent Inquiries:

If there are more than 2 inquiries in the last year:
Severity=10*(recentInquiries−2),
where recentinquiries is the number of inquiries in the last 12 months.
Illegal Mortgage Delinquencies:

If the account is a mortgage that has been transferred, and there is a new delinquency reported within the first 60 days after the transfer then the severity rating is severity rating is 200.

F. Credit Advisor

Credit report site 30, in one form, provides information to users concerning their current accounts payment profile, makes recommendations about consolidation or other actions, and facilitates the processing of applications for consolidation lines of credit.

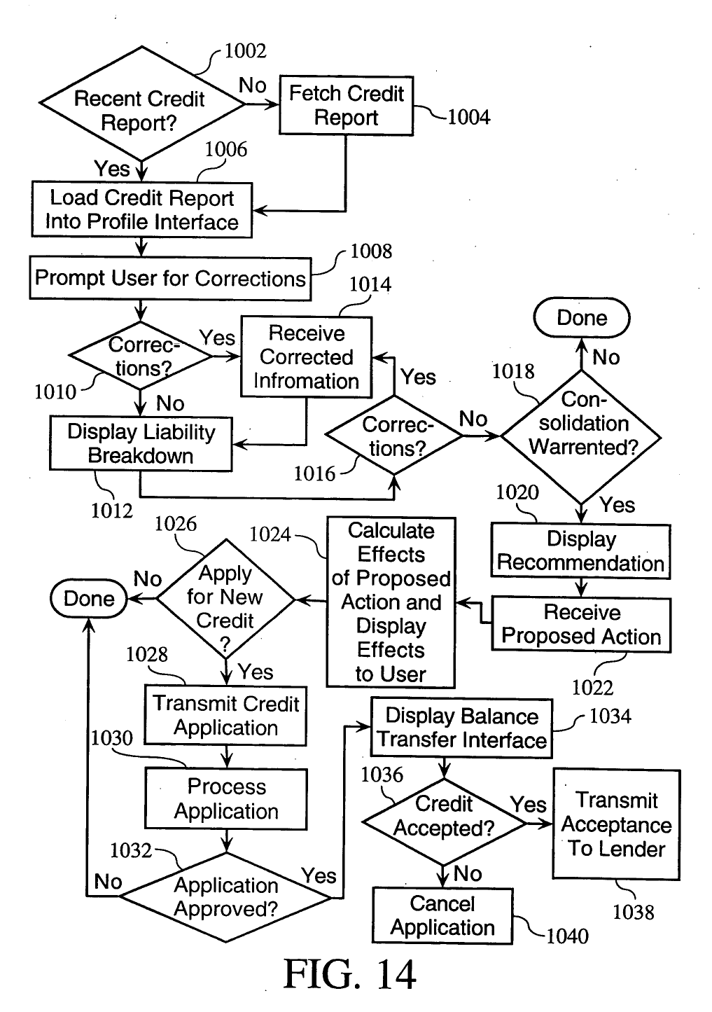

FIG. 14 illustrates one method for providing credit advising services according to the present invention. In one embodiment, when a user requests credit advising services, credit report site 30 fetches a new credit report, if a recent one does not exist (see FIG. 14, steps 1002 and 1004), and auto-populates the credit report data into a profile interface (step 1006), which is transmitted to the user. The user, in one embodiment, is prompted to correct any inaccurate account information [e.g. current balance, monthly payment, interest rates] (steps 1008, 1014). The user may also add additional accounts that were not reported in the credit profile, or remove accounts that do not belong to him.

Credit report site 30, in one embodiment, presents a graphical representation of the consumer's breakdown of liabilities, monthly payments, and interest payments according to credit type [e.g., revolving account, mortgage, installment, collections, etc] (step 1012). At this point, the user may revisit the details of their accounts and make adjustments (step 1016). Credit report site 30 then analyzes the user's credit profile. If the current balances and interest rates merit it (step 1018), credit report site 30 will make a recommendation to consolidate balances into a new line of credit to which balances may be transferred (step 1020). The interest rate and term on a recommended loan product will be used to calculate potential savings on monthly payments. The user can select those accounts that they would be interested in consolidating into the new loan product. In one embodiment, a graphical comparison between the total monthly payments and the proposed monthly payments will be displayed (step 1024).

If the user elects to apply for a new line of credit (step 1026), then credit report site 30 will transmit a credit application (step 1028). In one embodiment, the user must enter monthly income, employment information (pre-populated from the credit report), and (optionally) available assets. The loan application is processed on-line (step 1030), and a tentative approval/denial is returned pending verification of the information on the loan application (step 1032). In one embodiment, the tentative approval includes a precise credit limit and interest rate.

Based upon the approved line of credit, the consumer is allowed to enter how much balance to transfer from each existing account (step 1034). In one embodiment, the interface is pre-populated with transfer amounts that minimize the monthly payment or the interest payments. As the user adjusts the transfer amounts, the balance transfer interface presents a comparison between the current monthly payment/interest payment information with the proposed monthly payment/interest payment information. As FIG. 14 shows, the user, in one embodiment, has the option of accepting the new line of credit or canceling the application (step 1036). If the user accepts the credit, credit report site 30 transmits such acceptance to the lender (step 1038), which, in one embodiment, processes the application and makes the adjustments specified in the balance transfer interface. Otherwise, the application is canceled (step 1040).

1-11. (canceled)

12. A method for correlating data using a computer, said method comprising
retrieving a set of records;
applying an equivalence function to the records, wherein the equivalence function is operative to assess the similarity of a first record and a second record;
grouping, based on application of the equivalence function, the records into equivalence partitions, wherein each equivalence partition contains all records that are similar to at least one other record in the equivalence partition;
applying, within each equivalence partition, an exclusion function to the records, wherein the exclusion function is operative to assess the relative compatibility of a first record and a second record; and
grouping, based on application of the exclusion function, the records within each equivalence partition into exclusion partitions, wherein each record in an exclusion partition is mutually compatible with all other records and does not have a stronger compatibility with a record in the equivalence partition that is incompatible with any other record in the exclusion partition.

13. The method of claim 12 wherein the equivalence function comprises at least one supporting function operative to score the similarity of a first element in a first record to a second element in a second record.

14. The method of claim 12 wherein the retrieving step comprises the steps of
retrieving records from at least two credit report files; and,
assembling all records in a credit report category into a set of records.

15. The method of claim 12 further comprising
dividing the records into preliminary partitions based in part on a partition key; and,
applying the equivalence function to all pairs of records in the preliminary partitions to partition the records into equivalence partitions.

16. The method of claim 14 further comprising
dividing the records into preliminary partitions based in part on a partition key; and,
applying the equivalence function to all pairs of records in the preliminary partitions to partition the records into equivalence partitions.

17. The method of claim 15 wherein the partition key is the account open date.

18. The method of claim 13 further comprising
dividing the records into preliminary partitions based in part on a partition key; and,
applying the equivalence function to all pairs of records in the preliminary partitions to partition the records into equivalence partitions.

19. The method of claim 12 wherein the retrieved records correspond to a credit report category, and wherein the equivalence function is customized to the credit report category.

20-22. (canceled)

23. The method of claim 12 further comprising
for at least one exclusion partition, detecting the differences among the data in the records; and,
displaying the differences.

24. A method for correlating data using a computer, said method comprising
retrieving records from at least two credit report files;
converting the data in the records into a common format;
assembling all records in a credit report category into a set of records;
for at least one credit report category,
applying an equivalence function to the records, wherein the equivalence function is operative to assess the similarity of a first record and a second record;
grouping, based on application of the equivalence function, the records into equivalence partitions, wherein each equivalence partition contains all records that are similar to at least one other record in the equivalence partition;
applying, within each equivalence partition, an exclusion function to the records, wherein the exclusion function is operative to assess the relative compatibility of a first record and a second record;
grouping, based on application of the exclusion function, the records within each equivalence partition into exclusion partitions, wherein each record in an exclusion partition is mutually compatible with all other records and does not have a stronger compatibility with a record in the equivalence partition that is incompatible with any other record in the exclusion partition; and,
for at least one exclusion partition, merging the data in the records.

25-40. (canceled)

41. The method of claim 13 wherein the records correspond to a credit report, and wherein the first and second elements are account numbers.

42. The method of claim 13 wherein the records correspond to a credit report, and wherein the first and second elements are account open dates.

43. The method of claim 13 wherein the records correspond to a credit report, and wherein the first and second elements are account types.

44. The method of claim 13 wherein the records correspond to a credit report, and wherein the first and second elements are high credit values.

45. The method of claim 12 wherein the set of records are retrieved from at least first and second sources; and wherein the exclusion function determines whether a first record and a second record emanate from the same source.

46. The method of claim 45 wherein the exclusion function further determines whether the first and second records exhibit above a threshold level of matching.

47. The method of claim 46 wherein the exclusion function comprises at least one supporting function operative to score the similarity of a first element in the first record to a second element in the second record.

48. The method of claim 47 wherein the records correspond to a credit report, and wherein the first and second elements are account numbers.

49. The method of claim 47 wherein the records correspond to a credit report, and wherein the first and second elements are account open dates.

50. The method of claim 47 wherein the records correspond to a credit report, and wherein the first and second elements are account types.

51. The method of claim 47 wherein the records correspond to a credit report, and wherein the first and second elements are high credit values.

52. The method of claim 45 wherein a first record from the first source is incompatible with all other records from the first source.

53. The method of claim 12 further comprising, for at least one exclusion partition, merging the data in the records.

54. The method of claim 12 further comprising, for at least one exclusion partition, selecting the best representative record from the records in the exclusion partition.

55. The method of claim 24 wherein the retrieved records correspond to a credit report category, and wherein the equivalence function is unique to a given credit report category.

56. A method for correlating data using a computer, said method comprising
retrieving a set of records;
applying an equivalence function to the records, wherein the equivalence function is operative to assess the similarity of a first record and a second record;
grouping, based on application of the equivalence function, the records into equivalence partitions, wherein each equivalence partition contains all records that exhibit greater than a threshold similarity to at least one other record in the equivalence partition;
applying, within each equivalence partition, an exclusion function to the records, wherein the exclusion function is operative to assess the relative compatibility of a first record and a second record;
grouping, based on application of the exclusion function, the records within each equivalence partition into exclusion partitions, wherein each record in an exclusion partition is greater than a threshold compatibility with all other records and does not have a stronger compatibility with a record in the equivalence partition that exhibits a lower than the threshold compatibility with any other record in the exclusion partition; and,
for at least one exclusion partition, merging the data in the records.
